(19) United States
(12) Patent Application Publication
(10) Pub. No.: US 2025/0289369 A1
(43) Pub. Date: Sep. 18, 2025

(54) EFFICIENT CLOUD-BASED DYNAMIC MULTI-VEHICLE BEV FEATURE FUSION FOR EXTENDED ROBUST COOPERATIVE PERCEPTION

(71) Applicant: QUALCOMM Incorporated, San Diego, CA (US)

(72) Inventors: Kiran Bangalore Ravi, Paris (FR); Varun Ravi Kumar, San Diego, CA (US); Anantharaman Balasubramanian, San Diego, CA (US); Senthil Kumar Yogamani, Headford (IE)

(21) Appl. No.: 18/608,250

(22) Filed: Mar. 18, 2024

(51) Int. Cl. B60R 1/27; G06T 3/4038; G06V 10/80; G06V 20/58; H04W 4/44; H04W 4/46

(52) U.S. Cl. CPC B60R 1/27; G06T 3/4038; G06V 10/806; G06V 20/58; H04W 4/44; H04W 4/46; B60R 2300/303; B60R 2300/607

(57) ABSTRACT

An example system includes one or more memories for storing grid-free vehicle data and one or more processors configured to determine one or more first features from first vehicle data of the vehicle data, the first vehicle data being from a first vehicle of the plurality of vehicles. The one or more processors are configured to determine one or more second features from second vehicle data of the vehicle data, the second vehicle data being from a second vehicle of the plurality of vehicles. The one or more processors are configured to fuse the one or more first features and the one or more second features to generate fused features. The one or more processors are configured to generate a BEV representation based on the fused features.

### TECHNICAL FIELD

This disclosure relates to systems, including systems for multi-device, such as multi-vehicle, cooperative perception.

### BACKGROUND

An autonomous driving vehicle is a vehicle that is configured to sense the environment around the vehicle, such as the existence and location of other objects, and operating without or limited human control. An autonomous driving vehicle may include a Light Detection and Ranging (LiDAR) system, a camera system, and/or other sensor system for sensing data indicative of the existence and location of other objects around the autonomous driving vehicle. In some examples, such an autonomous driving vehicle may be referred to as an ego vehicle. A vehicle having an advanced driver-assistance systems (ADAS) is a vehicle that includes systems which may assist a driver in operating the vehicle, such as parking or driving the vehicle. An autonomous driving vehicle may, or may not, share sensor or other data with other autonomous driving vehicles for safety and/or other reasons.

### SUMMARY

The present disclosure generally relates to techniques and devices for processing multiple sensor system data from multiple devices (e.g., vehicles, robots, virtual reality (VR) devices, etc.) to compress and fuse bird's-eye-view (BEV) features for an extended and robust cooperative perception of space in the environment of the multiple devices. While the techniques of this disclosure are primarily discussed with respect to vehicles, it should be understood that these techniques are applicable for use with other devices, such as robots, VR devices, or other devices where cooperative perception of space may be desirable.

Single-agent (e.g., single vehicle) multi-sensor BEV frameworks have some limitations that can affect performance in certain scenarios. For example, single-agent BEV frameworks may have limited resolution and have limited coverage due to the number and position of cameras of the camera system for the device. This limited resolution may lead to less precise object detection, missing objects, and incomplete or imprecise segmentation than may be possible with a multi-agent (e.g., multi-vehicle) framework. Single-agent LiDAR and camera-based BEV frameworks may have limited accuracy in adverse weather conditions and limited scalability. As such, it may be desirable to utilize cooperative BEV perception with the use of multi-sensor and multi-vehicle systems.

However, cooperative (e.g., collaborative) BEV perception has its own challenges. Collaborative perception of the environment surrounding autonomous vehicles (AVs) is being developed using vehicle to vehicle (V2V) and vehicle to roadside unit (RSU) (V2X) interactions. Top-down “bird's-eye-view” (BEV) sensor data may be used, but existing techniques do not handle adaptive fusion of multi-modal (e.g., camera-LIDAR) sensor combinations. Additionally, the variable resolution of BEV grids across different sensor systems and different vehicles is a complicating factor.

The techniques of this disclosure may provide numerous benefits over existing techniques. For example, the techniques of this disclosure may provide for heterogeneous vehicle support. The techniques described herein allow for different types of vehicles to participate in the collaborative perception task, regardless of their sensing capabilities. Each vehicle may contribute to a shared map (e.g., a neighborhood map) using its own sensor data, and a system, which may reside on one or more servers in a cloud computing environment may perform inferences to obtain a shared perception of the environment.

The techniques of this disclosure may provide communication efficiency. In some examples, the system may transmit, to the vehicles, compact BEV features instead of raw sensor data. As such, the techniques of this disclosure may reduce or minimize the communication overhead between vehicles and the system. Additionally, the use of soft BEV features (described in further detail later herein) may further reduce the amount of data transmitted, as probabilities or likelihoods of object presence or attributes may be more compact than hard features and/or raw BEV feature data.

The techniques of this disclosure may provide robustness and accuracy in BEV maps. By fusing sensor data from multiple vehicles and performing inference on one or more servers in a cloud computing environment, the techniques of this disclosure may improve the robustness and accuracy of the shared map. Vehicles with incomplete or noisy sensor data may benefit from the information provided by other vehicles to the system, leading to a more comprehensive and accurate representation of the environment, thereby increasing the safety of navigation for all vehicles utilizing the shared map.

The techniques of this disclosure may provide privacy and security. The use of feature normalization and compression, as well as encryption for communication, may improve the privacy and security of the data transmitted between vehicles and the cloud. Privacy and security may be of interest given the sensitive nature of sensor data and the potential for malicious attacks.

Overall, the techniques of this disclosure may provide a scalable, efficient, and secure approach to collaborative perception in a multi-vehicle environment.

In one example, a system includes: one or more memories for storing vehicle data from each of the plurality of vehicles, the vehicle data being grid-free; and one or more processors in communication with the one or more memories, the one or more processors configured to: determine one or more first features from first vehicle data of the vehicle data, the first vehicle data being from a first vehicle of the plurality of vehicles; determine one or more second features from second vehicle data of the vehicle data, the second vehicle data being from a second vehicle of the plurality of vehicles; fuse the one or more first features and the one or more second features to generate fused features; and generate a BEV representation based on the fused features.

In another example, a method includes obtaining vehicle data from each of the plurality of vehicles, the vehicle data being grid-free; determining one or more first features from first vehicle data of the vehicle data, the first vehicle data being from a first vehicle of the plurality of vehicles; determining one or more second features from second vehicle data of the vehicle data, the second vehicle data being from a second vehicle of the plurality of vehicles; fusing the one or more first features and the one or more second features to generate fused features; and generating a BEV representation based on the fused features.

In another example, a computer-readable media stores instructions that, when applied by processing circuitry, causes the processing circuitry to obtain vehicle data from each of the plurality of vehicles, the vehicle data being grid-free; determine one or more first features from first vehicle data of the vehicle data, the first vehicle data being from a first vehicle of the plurality of vehicles; determine one or more second features from second vehicle data of the vehicle data, the second vehicle data being from a second vehicle of the plurality of vehicles; fuse the one or more first features and the one or more second features to generate fused features; and generate a BEV representation based on the fused features.

In another example, a system includes means for obtaining vehicle data from each of the plurality of vehicles, the vehicle data being grid-free; means for determining one or more first features from first vehicle data of the vehicle data, the first vehicle data being from a first vehicle of the plurality of vehicles; means for determining one or more second features from second vehicle data of the vehicle data, the second vehicle data being from a second vehicle of the plurality of vehicles; means for fusing the one or more first features and the one or more second features to generate fused features; and means for generating a BEV representation based on the fused features.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with one to more techniques of this disclosure.

FIG. 2 is a conceptual diagram illustrating a plurality of vehicles each having a respective BEV grid.

FIG. 3 is a block diagram of an example single agent BEV fusion architecture.

FIG. 4 is a block diagram of an example cooperative multi-vehicle late BEV fusion architecture.

FIG. 5 is a block diagram of an example cooperative multi-vehicle dynamic BEV intermediate feature fusion architecture according to one or more aspects of this disclosure.

FIG. 6 is a conceptual diagram illustrating sensor data captured by two example vehicles according to one or more aspects of this disclosure.

FIG. 7 is a block diagram illustrating an example architecture of a cooperative multi-vehicle dynamic BEV intermediate feature fusion system according to one or more aspects of this disclosure.

FIG. 8 is a conceptual diagram illustrating a multi-modal dynamic mask/frustum generator according to one or more aspects of this disclosure.

FIG. 9 is a block diagram illustrating a second encoder-decoder architecture for processing image data and position data in a continuous space to generate an output, in accordance with one to more techniques of this disclosure.

FIG. 10 is a block diagram illustrating example vehicle radial neighborhood embedding system according to one or more aspects of this disclosure.

FIG. 11 is a block diagram illustrating an example dynamic multi-modal grid fusion system according to one or more aspects of this disclosure.

FIG. 12 is a block diagram illustrating an example of trajectory-sensitive sub-sampling according to one or more aspects of this disclosure.

FIG. 13 is a flow diagram illustrating an example communication between a C2C server and a vehicle according to one or more aspects of this disclosure.

FIG. 14 is a flow diagram illustrating example multi-vehicle BEV feature fusion techniques according to one or more aspects of this disclosure.

### DETAILED DESCRIPTION

Multiple sensor systems, such as camera and Light Detection and Ranging (LiDAR) systems, may be used together in various different robotic, vehicular, and virtual reality (VR) applications. One such vehicular application is an advanced driver assistance system (ADAS). ADAS is a system that utilizes multiple sensor systems, such as camera and LiDAR sensor systems, to improve driving safety, comfort, and overall vehicle performance. Such a system combines the strengths of both sensors to provide a more comprehensive view of a vehicle's surroundings, enabling the ADAS to better assist the driver in various driving scenarios.

In some examples, a camera-based system is responsible for capturing high-resolution images and processing them in real time. The output images of such a camera-based system may be used in applications such as depth estimation, object detection, and/or pose detection, including the detection and recognition of objects, such as other vehicles, pedestrians, traffic signs, and lane markings. Cameras may be particularly good at capturing color and texture information, which is useful for accurate object recognition and classification.

LiDAR sensors emit laser pulses to measure the distance, shape, and relative speed of objects around the vehicle. LiDAR sensors provide three-dimensional (3D) data, enabling the ADAS to create a detailed map of the surrounding environment. LiDAR may be particularly effective in low-light or adverse weather conditions, where camera performance may be hindered. In some examples, the output of a LiDAR sensor may be used as partial ground truth data for determining neural network-based depth information on corresponding camera images.

By fusing the data gathered from both camera and LiDAR sensors, an ADAS or another kind of system, can deliver enhanced situational awareness and improved decision-making capabilities. This enables various driver assistance features such as adaptive cruise control, lane keeping assist, pedestrian detection, automatic emergency braking, and parking assistance. The combined system can also contribute to the development of semi-autonomous and fully autonomous driving technologies, which may lead to a safer and more efficient driving experience.

However, single-agent (e.g., single vehicle) multi-sensor BEV frameworks have some limitations that can affect performance in certain scenarios. For example, single-agent BEV frameworks may have limited resolution due to the number and position of cameras of the camera system for the vehicle. This limited resolution may lead to less precise object detection and segmentation than may be possible with a multi-agent (e.g., multi-vehicle) framework. A single-agent (or a limited number of cameras) BEV framework may also have limited coverage. For example, a single or limited number of cameras on a single vehicle may not be able to capture the entire field of view required for accurate BEV segmentation. This can lead to missing objects or incomplete segmentation. A single-agent BEV framework may also have limited accuracy in complex scenes. For example, such a framework may have difficulty accurately segmenting objects in complex scenes including occlusions and/or crowded environments. Single-agent LiDAR and camera-based BEV frameworks may have limited accuracy in adverse weather conditions. For example, single agent LiDAR and camera-based BEV frameworks can be affected by adverse weather conditions such as rain, snow, or fog, which can reduce accuracy and make it more difficult to detect objects. Single-agent BEV frameworks may also have limited scalability. For example, single-agent BEV frameworks may be less scalable than multi-agent frameworks, as adding additional sensors may not necessarily improve the overall performance of a framework. Single-agent multi-sensor BEV has limitations, including limited resolution, coverage, accuracy, and scalability. As such, it may be desirable to utilize cooperative BEV perception with the use of multi-sensor and multi-vehicle systems.

Collaborative perception of the environment surrounding autonomous vehicles (AVs) is being developed using vehicle to vehicle (V2V) and vehicle to roadside unit (RSU) (V2X) interactions. Top-down bird's-eye-view (BEV) sensor data may be used, but existing techniques do not handle adaptive fusion of multi-modal (e.g., camera-LIDAR) sensor combinations. Additionally, the variable resolution of BEV grids is a complicating factor.

Generally, collaborative perception may be classified into three different levels-early collaboration, intermediate collaboration, and late collaboration. With early collaboration, different vehicles may share raw collected data. With intermediate collaboration, different vehicles may process data to extract features and share the extracted features. With late collaboration, different vehicles may process data and features to generate output (e.g., BEV grids) and share the outputs. Intermediate collaboration may include data that is relatively easy to compress and that maintains geometric features of the data. BEV features generally include common representations across vehicles.

Collaborative adaptive feature fusion is now discussed. Intermediate level feature fusion is an important issue when considering connected autonomous vehicles (CAVs) which interact dynamically. Qiao, D. and Zulkernine, F., “Adaptive Feature Fusion for Cooperative Perception using LiDAR Point Clouds” Queen's University, Canada (available at arxiv.org/pdf/2208.00116.pdf) (hereinafter referred to as “Qiao, et al.”), describe different adaptive late fusion techniques while maintaining a maximum static number of interacting CAVs so as to avoid having to handle dynamic number of CAVs. However, the authors do not address adaptive fusion for the multi-modal camera-LiDAR cases where there are various sensor combinations (camera-LiDAR, camera-radar, camera-camera, LiDAR-LiDAR, LiDAR-radar, etc.) across vehicles, and also do not address the variable resolution of BEV grids, which may be indicative of or based on the sensor resolution of the different sensors.

However, enhancing perception tasks, such as 3D detection or segmentation, by dynamically fusing BEV features across interacting vehicles with multi-modal sensor sets (e.g., camera/lidar/radar, equipped potentially with different set(s) of sensors), has challenges. As such, it may be desirable to address a number of such challenges when implementing a multi-vehicle BEV system.

Challenges in implementing a multi-vehicle BEV system may include performing relatively early feature fusion, handling changes in ego-pose orientations and position with multiple vehicles, overcoming differences in BEV grid resolution between vehicles (e.g., due to sensor set characteristics, lidar range, camera and lidar resolution), handling dynamic objects between different vehicle perception inputs, and handling changes in distortion and thus BEV features due to objects positions in different locations in a field of view and/or camera in a multi-camera setup between different vehicles.

According to the techniques of this disclosure, a multi-vehicle BEV system may include relatively early dynamic BEV feature fusion which fuses BEV features obtained from neighboring vehicles. The system may create a unified representation of BEV features that incorporates information from multiple CAV BEV grids and that may be used by the multiple CAVs. The system may handle changes in intra vehicle poses (e.g., rotation and translation). For example, given a neighborhood within which CAVs are present, CAVs may have different relative changes in rotation and translation. Such a neighborhood may include a geographical area around one or more of the CAVS, or an RSU, which includes, for example, a current location of each of the cooperating CAVs. For successful feature fusion, the system may align grids across a special Euclidean group 3 (SE3) transformation group, even if all CAVs have the same BEV grid size and resolution.

The system may fuse BEV features for grids having different resolutions. For example, each vehicle within the group may have a different BEV grid resolution, which refers to the size and granularity of the grid used to represent the region around the vehicle. These variations may be accounted for to ensure consistent and accurate fusion of BEV features.

The system may handle dynamic objects between vehicle perception inputs. For example, as the vehicles move across the region, the scene may contain dynamic objects, such as pedestrians or other vehicles which may not be part of the group. These dynamic objects can introduce complexities in fusing the BEV features, as their positions and appearances can change between the perception inputs of two or more vehicles.

The system may handle change in distortion and camera setup. For example, in a multi-camera setup, the distortion and camera parameters may differ between pairs of vehicles. Objects at different locations in the field of view (FOV) can result in varying distortions (e.g., positive and/or negative scaling based on relative movement of CAVs), affecting the BEV features obtained from the cameras. Accurate fusion of features between vehicles may depend on handling these changes.

This disclosure describes real time cooperative perception using BEV fusion models for autonomous driving systems. The techniques of this disclosure allow for different vehicles to have different combinations of sensors (e.g., multi-camera only, multi-camera and LiDAR, LiDAR only, camera and radar, etc.), as well allow for the intersection of BEV grids of multiple vehicles. The present disclosure generally relates to techniques and devices for generating BEV features based on a plurality of vehicles. It should be noted that the techniques of this disclosure may be implemented in one or more servers, one or more RSUs, and/or one or more vehicles.

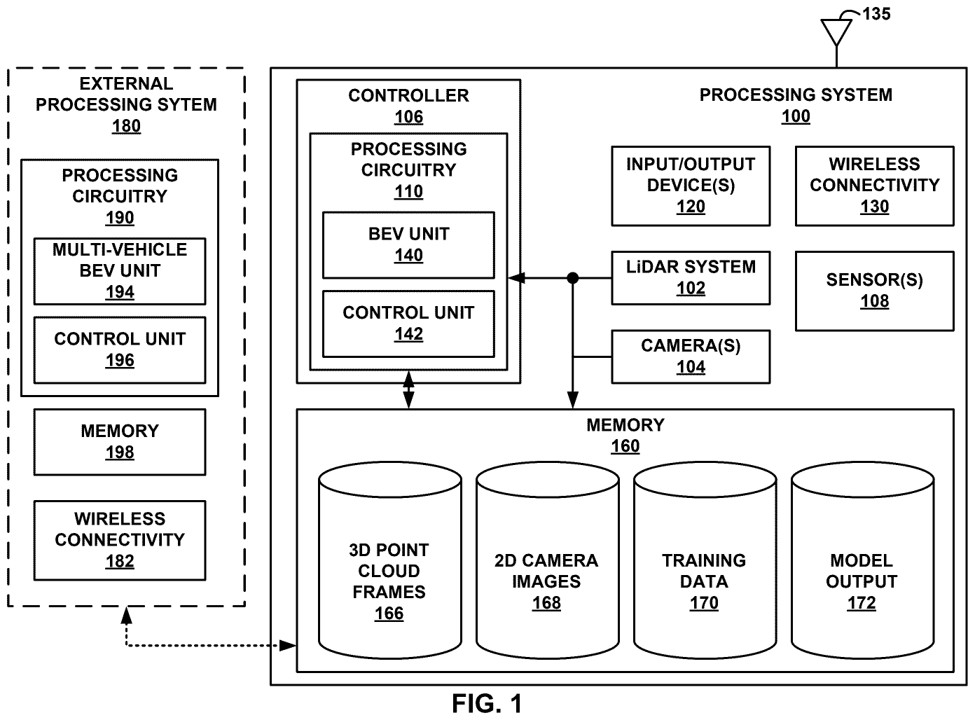

FIG. 1 is a block diagram illustrating an example processing system 100, in accordance with one to more techniques of this disclosure. Processing system 100 may be used in a vehicle, such as an autonomous driving vehicle or an assisted driving vehicle (e.g., a vehicle having an ADAS or an “ego vehicle”). In such an example, processing system 100 may represent an ADAS. In other examples, processing system 100 may be used in robotic applications, VR applications, or other kinds of applications that may include a plurality of sensor systems, such as a camera and a LiDAR system. The techniques of this disclosure are not limited to vehicular applications. The techniques of this disclosure may be applied by any system that processes data from a plurality of devices or systems.

Processing system 100 may include LiDAR system 102, camera(s) 104, controller 106, one or more sensor(s) 108, input/output device(s) 120, wireless connectivity component 130, and/or memory 160. LiDAR system 102 may include one or more light emitters (e.g., lasers) and one or more light sensors. LiDAR system 102 may, in some cases, be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 is not limited to being deployed in or about a vehicle. LiDAR system 102 may be deployed in or about another kind of object.

In some examples, the one or more light emitters of LiDAR system 102 may emit such pulses in a 360-degree field around the vehicle so as to detect objects within the 360-degree field by detecting reflected pulses using the one or more light sensors. For example, LiDAR system 102 may detect objects in front of, behind, or beside LiDAR system 102. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. LiDAR processing circuitry of LiDAR system 102 may generate one or more point cloud frames based on the one or more optical signals emitted by the one or more light emitters of LiDAR system 102 and the one or more reflected optical signals sensed by the one or more light sensors of LiDAR system 102. These points are generated by measuring the time it takes for a laser pulse to travel from a light emitter to an object and back to a light detector. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization: Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. Cameras used to capture color information for point cloud data may, in some examples, be separate from camera(s) 104. The color attribute includes color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera(s) 104 may include any type of camera configured to capture video or image data in the environment around processing system 100 (e.g., around a vehicle). In some examples, processing system 100 may include multiple camera(s) 104. For example, camera(s) 104 may include a front facing camera (e.g., a front bumper camera, a front windshield camera, and/or a dashcam), a rear facing camera (e.g., a backup camera), side facing cameras (e.g., cameras mounted in sideview mirrors). Camera(s) 104 may include a color camera or a grayscale camera. In some examples, camera(s) 104 may be a camera system including more than one camera sensor. Sensor(s) 108 may include radar sensor, a location sensor, a sonar sensor, an infrared camera, and/or a time-of-flight (ToF) camera.

LiDAR system 102 may, in some examples, be configured to collect 3D point cloud frames 166. Camera(s) 104 may, in some examples, be configured to collect 2D camera images 168. An importance of data input modalities such as 3D point cloud frames 166 and 2D camera images 168 may vary for indicating one or more characteristics of objects in a 3D environment. For example, when color and texture are important characteristics of a first object and when color and texture are not important characteristics of a second object, 2D camera images 168 may be more important for identifying characteristics of the first object as compared with the importance of 3D point cloud frames 166 for identifying characteristics of the second object. It may be beneficial to consider the importance of 3D point cloud frames 166 and 2D camera images 168 for indicating characteristics of a 3D environment when generating BEV features corresponding to 3D point cloud frames 166 and/or generating BEV features corresponding to 2D camera images 168.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135. Processing system 100 may communicate with external processing system and/or processing systems of other devices (e.g., other vehicles) via wireless connectivity component 130.

Processing system 100 may also include one or more input/output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processing circuitry 110. Controller 106 is not limited to controlling vehicles. Controller 106 may additionally or alternatively control any kind of controllable device, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with LiDAR system 102, camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. Sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), and/or another kind of hard disk. Examples of memory 160 include solid state memory and/or a hard disk drive. In some examples, memory 160 is used to store computer-readable, computer-executable software including instructions that, when applied, cause one or more processors to perform various functions described herein. In some cases, memory 160 contains, among other things, a basic input/output system (BIOS) which controls basic hardware or software operation such as the interaction with peripheral components or devices. In some cases, a memory controller operates memory cells of memory 160. For example, the memory controller can include a row decoder, column decoder, or both. In some cases, memory cells within memory 160 store information in the form of a logical state.

Processing system 100 may be configured to perform techniques for extracting features from image data and position data, processing the features, fusing the features, or any combination thereof. In some examples, processing system 100 may perform a portion of such techniques while external processing system 180 may perform another portion of such techniques.

Processing circuitry 110 may include BEV unit 140. BEV unit 140 may be implemented in software, firmware, and/or any combination of hardware described herein. As will be described in more detail below, BEV unit 140 may be configured to receive a plurality of 2D camera images 168 captured by camera(s) 104 and receive a plurality of 3D point cloud frames 166 captured by LiDAR system 102. BEV unit 140 may be configured to receive 2D camera images 168 and 3D point cloud frames 166 directly from camera(s) 104 and LiDAR system 102, respectively, or from memory 160. In some examples, the plurality of 3D point cloud frames 166 may be referred to herein as “position data.” In some examples, the plurality of 2D camera images 168 may be referred to herein as “image data.”

In the case of a single-agent system, BEV unit 140 may fuse features corresponding to the plurality of 3D point cloud frames 166 and features corresponding to the plurality of 2D camera images 168 in order to combine image data corresponding to one or more objects within a 3D space with position data corresponding to the one or more objects. For example, each camera image of the plurality of 2D camera images 168 may comprise a 2D array of pixels that includes image data corresponding to one or more objects. Each point cloud frame of the plurality of 3D point cloud frames 166 may include a 3D multi-dimensional array of points corresponding to the one or more objects. Since the one or more objects are located in the same 3D space where processing system 100 is located, it may be beneficial to fuse features of the image data present in 2D camera images 168 that indicate information corresponding to the identity one or more objects with features of the position data present in the 3D point cloud frames 166 that indicate a location of the one or more objects within the 3D space. This is because image data may include at least some information that position data does not include, and position data may include at least some information that image data does not include.

Fusing features of image data and features of position data may provide a more comprehensive view of a 3D environment corresponding to processing system 100 as compared with analyzing features of image data and features of position data separately. For example, the plurality of 3D point cloud frames 166 may indicate an object in front of a processing system 100, and BEV unit 140 may be able to process the plurality of 3D point cloud frames 166 to determine that the object is a stoplight. This is because the plurality of 3D point cloud frames 166 may indicate that the object includes three round components oriented vertically and/or horizontally relative to a surface of a road intersection, and the plurality of 3D point cloud frames 166 may indicate that the size of the object is within a range of sizes that stoplights normally occupy. But the plurality of 3D point cloud frames 166 might not include information that indicates which of the three lights of the stoplight is turned on and which of the three lights of the stoplight is turned off. 2D camera images 168 may include image data indicating that a green light of the stoplight is turned on, for example. This means that it may be beneficial to fuse features of image data with features of position data so that BEV unit 140 can analyze image data and position data to determine characteristics of one or more objects within the 3D environment.

Fusing image data BEV features and position data BEV features may involve associating image data BEV features with position data BEV features corresponding to the image data BEV features. For example, processing system 100 may fuse image data BEV features indicating a color and an identity of a stoplight with position data BEV features indicating a position of the stoplight. This means that the fused set of BEV features may include information from both image data and position data corresponding to the stoplight that is important for generating an output. Some systems may fuse image data BEV features with position data BEV features by generating “grids” of image data BEV features with position data BEV features and fusing the grids. A BEV feature grid may correspond to a 2D BEV of a 3D environment. Each “cell” of the BEV feature grid may include features corresponding to a portion of the 3D environment corresponding to the cell. This allows the system to fuse image data BEV features with position data BEV features corresponding to the same portion of the 3D environment. In some examples, the grid itself (e.g., not the BEV features which may be within the grid) may be referred to as grid information.

BEV grid resolution may be chosen to reduce memory consumption similar to how voxel grid sizes are chosen in point cloud DNN architectures. In some examples, a fixed grid size may be 128 cells by 128 cells with a resolution of 80 centimeters (cm) for each cell in the grid. Low-resolution BEV grids may lead to poor resolution coarse features being extracted. This may lead to poor detection of images. Features extracted in the BEV grid may be sensitive to grid resolution. Poor resolution may result in poor detection of pedestrians, traffic signs and other thin and flat objects, while lanes/roads segments with larger surface area in BEV may be detected better. BEV fusion models may use an up-sampling layer to handle low resolution grids.

A cooperative, multi-agent (e.g., multi-vehicle) system, according to the techniques of this disclosure, may provide improved resolution for vehicles having lower resolution BEV systems, as features from higher resolution systems of other vehicles may be fused into a shared, neighborhood map, which may retain the higher resolution. The shared, neighborhood map may include a geographical area around one or more of the CAVS, or an RSU, which includes, for example, a representation of a current location of each of the cooperating CAVs.

External processing system 180 may represent one or more servers in a cloud computing environment and/or a roadside unit. External processing system 180 may obtain (e.g., receive) data from processing system 100 and similar processing systems and process the received data, for example, to fuse BEV feature data from a plurality of vehicles.

It should also be noted that, in some examples, processing system 100 may obtain (e.g., receive) data from another processing system 100 and similar processing systems and process the received data, for example, to fuse BEV feature data from a plurality of vehicles, including, for example, a vehicle in which the processing system 100 is located. In such cases, BEV unit 140 may also include a multi-vehicle BEV unit, like multi-vehicle BEV unit 194 discussed below.

External processing system 180 may include processing circuitry 190, which may be any of the types of processors described above for processing circuitry 110. Processing circuitry 190 may include a multi-vehicle BEV unit 194 that is configured to fuse BEV features from multiple vehicles for cooperative perception. Processing circuitry 190 may obtain data from controller 106 or from memory 160. External processing system 180 may also include memory 198 that may be configured to store data obtained from processing system 100 and other similar processing systems. Memory 198 may also be configured to store training data (similar to training data 170) and model output (similar to model output 172) for encoders, decoders, or other models that are part of multi-vehicle BEV unit 194. Memory 198 may include any of the types of memory described above for memory 160.

Wireless connectivity component 182 may facilitate communication between external processing system 180 and processing system 100. Wireless connectivity component 182 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards.

Multi-vehicle BEV unit 194 may generate fused BEV representations based on information received from processing system 100 and other similar systems. Processing circuitry 190 may transmit or send the fused BEV representations to processing system 100 via wireless connectivity component 182. Processing circuitry 110 may apply control unit 142 to control, based on the fused BEV representations from external processing system 180, which in some examples, may be further processed by BEV unit 140, a device (e.g., a vehicle, a robotic arm, or another device) corresponding to processing system 100. Control unit 142 may control the device based on information included in the fused BEV representations relating to one or more objects within a 3D space including processing system 100. For example, the fused BEV representations and/or the output of BEV unit 140 may include an identity of one or more objects, a position of one or more objects relative to the processing system 100, characteristics of movement (e.g., speed, acceleration) of one or more objects, or any combination thereof. Based on this information, control unit 142 may control the device corresponding to processing system 100. The fused BEV representations may be stored in memory 160 as model output 172.

In some examples, processing circuitry 110 may be configured to train one or more encoders, decoders, or any combination thereof applied by BEV unit 140 using training data 170. For example, training data 170 may include one or more training point cloud frames and/or one or more camera images. Training data 170 may additionally or alternatively include features known to accurately represent one or more point cloud frames and/or features known to accurately represent one or more camera images. This may allow processing circuitry 110 to train one or more encoders to generate features that accurately represent point cloud frames and train one or more encoders to generate features that accurately represent camera images. Processing circuitry 110 may also use training data 170 to train one or more decoders. In some examples, training data 170 may be stored separately from processing system 100. In some examples, processing circuitry other than processing circuitry 110 and/or processing circuitry 190 and separate from processing system 100 may train one or more encoders, decoders, or any combination thereof applied by BEV unit 140 using training data 170.

In some examples, processing circuitry 190 may be configured to train one or more encoders, decoders, or any combination thereof applied by multi-vehicle BEV unit 194 using training data, such as training data 170. For example, training data 170 may include one or more training point cloud frames and/or one or more camera images. Training data 170 may additionally or alternatively include features known to accurately represent one or more point cloud frames and/or features known to accurately represent one or more camera images. This may allow processing circuitry 190 to train one or more encoders to generate features that accurately represent point cloud frames and train one or more encoders to generate features that accurately represent camera images. Processing circuitry 190 may also use training data 170 to train one or more decoders. In some examples, training data 170 may be stored in memory 198.

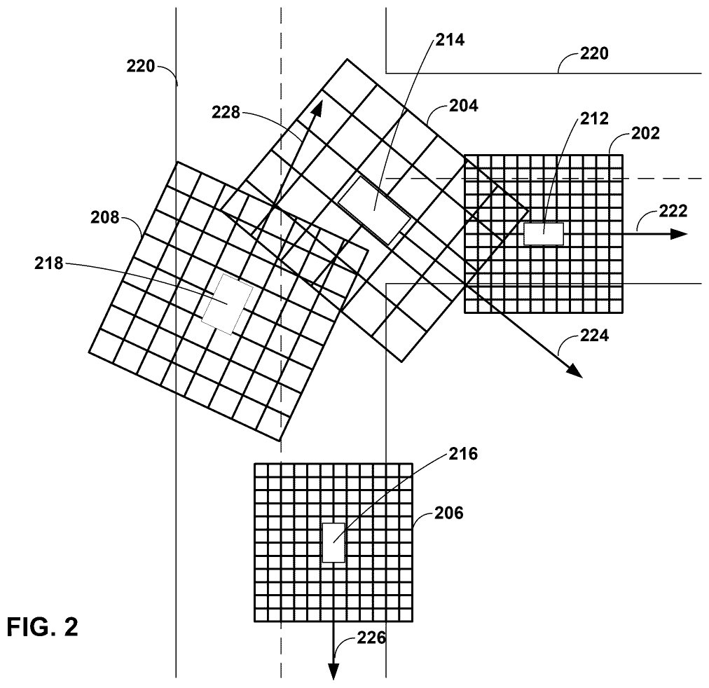

FIG. 2 is a conceptual diagram illustrating a plurality of vehicles each having a respective BEV grid. In the example of FIG. 2, vehicle 212, vehicle 214, vehicle 216, and vehicle 218 are shown traveling on streets 220. Vehicle 212 has an associated BEV grid 202 which may be generated by one or more processors (e.g., of processing circuitry 110 and/or processing circuitry 190) based on sensor data of vehicle 212. For example, vehicle 212 may include LiDAR system 102, camera(s) 104 and/or sensor(s) 108 which may capture information (e.g., image data, point cloud data, and/or the like) which may be fused to create BEV grid 202. Similarly, vehicle 214 has an associated BEV grid 204 which may be generated by one or more processors based on sensor data of vehicle 214. Vehicle 216 has an associated BEV grid 206 which may be generated by one or more processors based on sensor data of vehicle 216. Vehicle 218 has an associated BEV grid 208 which may be generated by one or more processors based on sensor data of vehicle 218. BEV grids 202, 204, 206, and 208 may be different in size of grid cells, in the number of grid cells, and/or in overall size, for example, due to differences in the resolution and/or set up of sensor systems of the vehicles of FIG. 2. In the example where each of vehicles 212, 214, 216, and 218 are single-agents, the one or more processors generating each of the BEV grids 202, 204, 206, and 208 typically include one or more processors on board the respective associated vehicle.

Vehicle 212 also is shown having a travel vector 222 indicative of a velocity and a direction of travel. Vehicle 214 has travel vector 224, vehicle 216 has travel vector 226, and vehicle 218 has travel vector 228. As time progresses and vehicles 212, 214, 216, and 218 move relative to each other according to their respective travel vectors. Additionally, travel vectors 222, 224, 226, and/or 228 may change over time, based on activity of steering, braking, and/or acceleration systems of vehicles 212, 214, 216, and/or 218, as the vehicles navigate streets 220. Because each of vehicles 212, 214, 216, and 218 are in motion in various directions as indicated by their associated travel vectors, the pose and position of each vehicle with respect to the other vehicles changes over time, complicating the effective sharing of sensed information between vehicles 212, 214, 216, and/or 218.

As can be seen, BEV grids 202 and 204 overlap. Additionally, BEV grids 208 and 204 overlap. The overlap of such BEV grids may be utilized to provide additional precision to object detection by utilizing multi-agent (multiple vehicle) techniques of this disclosure when compared to each vehicle's own separate BEV grid. For example, BEV grid 204 has less resolution than BEV grids 202 and 208, making accurate placement of an object less likely within BEV grid 204 than within BEV grid 202 and BEV grid 208.

Additionally, through the use of the multi-agent techniques of this disclosure, information from each vehicle's sensor systems within a particular area may be shared. For example, even though BEV grid 208 does not overlap with BEV grid 202, objects sensed by vehicle 212 (e.g., objects represented within BEV grid 202) may be encountered by vehicle 218 as vehicle 218 navigates streets 220. Even though BEV grid 206 does not overlap with any other BEV grid in FIG. 2 and travel vector 226 indicates vehicle 216 is moving away from the other vehicles, information regarding an object sensed by vehicle 216 may be of interest to vehicles 212, 214, and/or 218 as such an object may be in motion itself and may be moving towards vehicles 212, 214, and/or 218.

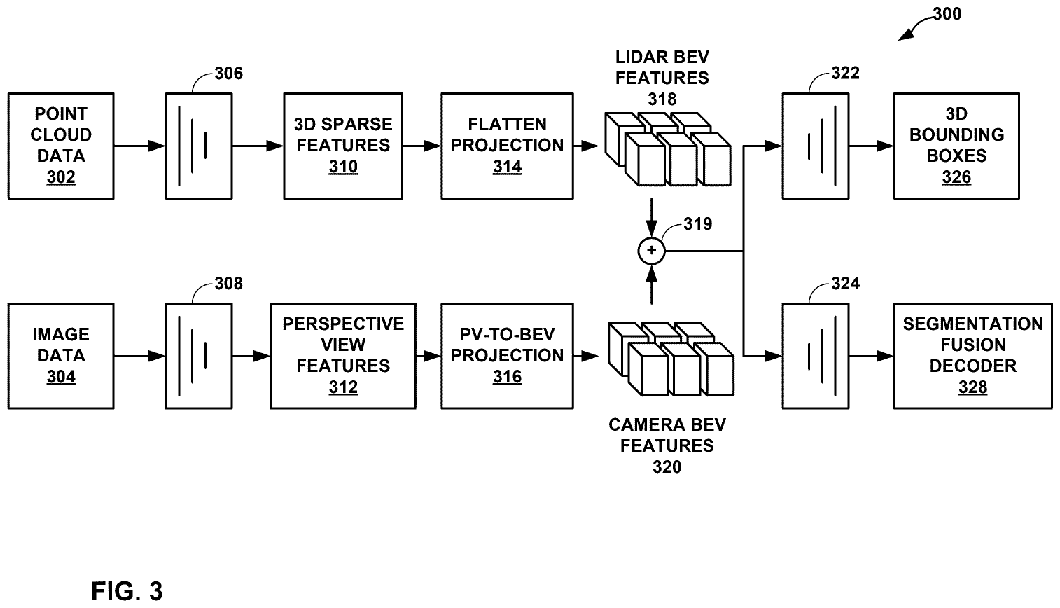

FIG. 3 is a block diagram of an example single agent BEV fusion architecture. For example, vehicle 212 may include architecture 300 which may be used to generate BEV grid 202. Vehicle 212 may obtain point cloud data 302 from, e.g., LiDAR system 102 (FIG. 1). Encoder 306 may encode point cloud data 302 to extract 3D sparse features 310. Vehicle 212 may flatten a projection via flatten projection unit 314, for example, from 3D to 2D. Vehicle 212 may obtain therefrom LiDAR BEV features 318.

Vehicle 212 may also obtain image data 304 from, e.g., camera(s) 104 (FIG. 1). Encoder 308 may encode image data 304 to obtain perspective view features 312. Vehicle 212 may perform a perspective view-to BEV projection transformation with PV-to-BEV projection unit 316 to obtain camera BEV features 320.

Feature fusion unit 319 may fuse LiDAR BEV features 318 and camera BEV features 320. The output of feature fusion unit 319 may be decoded by decoder 322 to generate 3D bounding boxes 326 and by decoder 324 and further decoded by segmentation fusion decoder 328.

Encoders 306 and 308 may be configured to extract information from input data and process the extracted information to generate an output. In general, encoders are configured to receive data as an input and extract one or more features from the input data. The features are the output from the encoder. The features may include one or more vectors of numerical data that can be processed by a machine learning model. These vectors of numerical data may represent the input data in a way that provides information concerning characteristics of the input data. In other words, encoders are configured to process input data to identify characteristics of the input data.

Encoders 306 and 308 may represent encoders of neural networks such as a convolutional neural network (CNN), another kind of artificial neural network (ANN), or another kind of model that includes one or more layers and/or nodes that is configured to extract information from input data and process the extracted information to generate an output. Examples of layers include input layers, output layers, and hidden layers between the input layers and the output layers. A CNN, for example, may include one or more convolutional layers comprising convolutional filters. Each convolutional filter may perform one or more mathematical operations on the input data to detect one or more features such as edges, shapes, textures, or objects. CNNs may additionally or alternatively include activation functions that identify complex relationships between elements of a point cloud data 302 and/or image data 304 and pooling layers that recognize patterns regardless of location within point cloud data 302 and/or image data 304.

Architecture 300 may include one or more encoders (e.g., encoder 306, encoder 308, flatten projection unit 314, PV-to-BEV projection unit 316) and one or more decoders (e.g., decoder 322, decoder 324, segmentation fusion decoder 328). Architecture 300 may be configured to process image data 304 and position data (e.g., point cloud data 302). An encoder-decoder architecture for image feature extraction can be used in computer vision tasks, such as image captioning, image-to-image translation, and image generation. The encoder-decoder architecture may transform input data into a compact and meaningful representation known as a feature vector that captures salient visual information from the input data. The encoder may extract features from the input data, while the decoder reconstructs the input data from the learned features.

In some cases, an encoder (e.g., encoder 306, encoder 308, flatten projection unit 314, PV-to-BEV projection unit 316) is built using CNN layers to analyze input data in a hierarchical manner. The CNN layers may apply filters to capture local patterns and gradually combine them to form higher-level features. Each convolutional layer extracts increasingly complex visual representations from the input data. These representations may be compressed and down sampled through operations such as pooling or strided convolutions, reducing spatial dimensions while preserving desired information. The final output of the encoder may represent a flattened feature vector that encodes the input data's high-level visual features.

A decoder (e.g., decoder 322, decoder 324, segmentation fusion decoder 328) may be built using transposed convolutional layers or fully connected layers, may reconstruct the input data from the learned feature representation. A decoder may take the feature vector obtained from the encoder as input and processes the feature vector to generate an output that is similar to the input data. The decoder may up-sample and expand the feature vector, gradually recovering spatial dimensions lost during encoding. A decoder may apply transformations, such as transposed convolutions or deconvolutions, to reconstruct the input data. The decoder layers progressively refine the output, incorporating details and structure until a visually plausible image is generated.

During training, an encoder-decoder architecture for feature extraction is trained using a loss function that measures the discrepancy between the reconstructed image and the ground truth image. This loss guides the learning process, encouraging the encoder to capture meaningful features and the decoder to produce accurate reconstructions. The training process may involve minimizing the difference between the generated image and the ground truth image, typically using backpropagation and gradient descent techniques. Encoders and decoders of architecture 300 may be trained using training data 170 stored by the memory 160 of FIG. 1. Additionally, or alternatively, encoders and decoders of architecture 300 may be trained using training data stored separately from memory 160.

As illustrated, encoders of architecture 300 may extract high-level features from the input data and decoders of architecture 300 may reconstruct the input data from the learned features. This architecture may allow for the transformation of input data into compact and meaningful representations. The encoder-decoder architecture may enable the model to learn and utilize important visual and positional features, facilitating tasks like image generation, captioning, and translation.

Encoder 306 may encode point cloud data 302 to extract 3D sparse features 310. Flatten projection unit 314 may represent an encoder that is configured to perform one or more tasks involving one or more spatial transformations, such as to flatten a projection of 3D sparse features 310. For example, flatten projection unit 314 may include a spatial transformer network (STN) including localization and sampling generation modules that spatially transform input data. An STN, such as flatten projection unit 314, may perform geometric transformations on 3D sparse features 310 to improve an alignment of 3D sparse features 310 and/or or to adapt 3D sparse features 310 for specific tasks. Flatten projection unit 314 may output LiDAR BEV features 318.

Encoder 308 may encode image data 304 to extract perspective view features 312. PV-to-BEV projection unit 316 may represent an encoder that is configured to perform one or more tasks involving one or more spatial transformations, such as to project the perspective view features into a BEV format and may output camera BEV features 320. For example, PV-to-BEV projection unit 316 may include an STN including localization and sampling generation modules that spatially transform input data. An STN, such as PV-to-BEV projection unit 316, may perform geometric transformations on perspective view features 312 to improve an alignment of perspective view features 312 and/or or to adapt perspective view features for specific tasks.

Feature fusion unit 319 may be configured to fuse LiDAR BEV features 318 and camera BEV features 320 to generate a fused set of 3D features. In some examples, feature fusion unit 319 may use a concatenation operation to fuse LiDAR BEV features 318 and camera BEV features 320 to generate the set of 3D features so that the fused set of 3D features includes useful information present in each of fuse LiDAR BEV features 318 and camera BEV features 320.

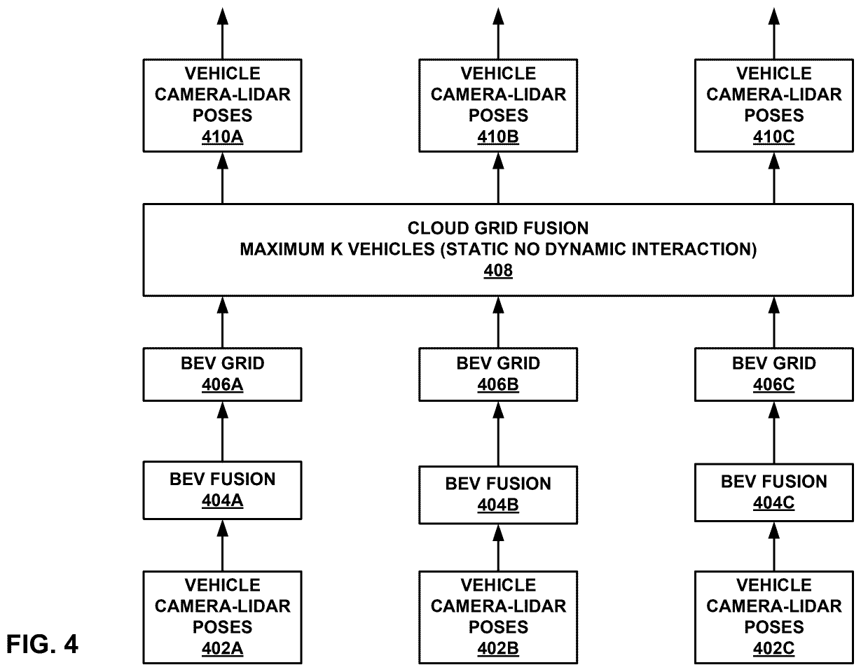

FIG. 4 is a block diagram of an example cooperative multi-vehicle late BEV fusion architecture. A cooperative BEV baseline is now described. In this example, three vehicles are involved in the cooperative BEV process.

Each vehicle may determine respective vehicle camera and LiDAR sensor poses. For example, a first vehicle may determine vehicle camera-LiDAR poses 402A associated with the first vehicle, a second vehicle may determine vehicle camera-LiDAR poses 402B associated with the second vehicle, and a third vehicle may determine vehicle camera-LiDAR poses 402C associated with the third vehicle. In other words, each vehicle may determine poses of its own camera and/or LiDAR system.

Each of the three vehicles may perform BEV fusion (e.g., BEV fusion 404A, BEV fusion 404B, and BEV fusion 404C) of their own camera and LiDAR (or other sensor) data. Each of the three vehicles may generate their own BEV grid (e.g., BEV grid 406A, BEV grid 406B, and BEV grid 406C). For example, each of the three vehicles may include an architecture similar to that of FIG. 3 and generate their own BEV grids based on their own sensor data (e.g., point cloud data and image data).

BEV grids 406A-406C may be obtained by a cloud-based computing system (e.g., one or more servers) which may perform cloud grid fusion 408, fusing BEV grids 406A-406C. In this example, a maximum number of vehicles (e.g., 3) may be part of the group whose BEV grids are fused. Each of the vehicles may then obtain from the cloud grid fusion 408 a fused BEV grid. This process may then repeat, as any of the three vehicles may have moved and the poses of the camera and/or LiDAR systems may have changed. For example, the first vehicle may determine vehicle camera-LiDAR poses 410A, the second vehicle may determine vehicle camera-LiDAR poses 410B, and the third vehicle may determine vehicle camera-LiDAR poses 410C.

This baseline includes the late fusion of BEV grids per vehicle and the adaptive feature fusion for LiDAR described in Qiao et al. Such a baseline may be relatively simple to implement and may include BEV-detections and segmentation directly into a global coordinate system that may be shared with other vehicles and/or actors in the scene. Data sharing is relatively compact, with only the output of the BEV fusion models being shared.

However, objects in the FOV of two different vehicle's cameras may have different features. For example, a single object may appear very different across different viewpoints. The scale of the object may be different from the different vehicles' camera viewpoints. In this baseline system, there is not a way to associate these viewpoints and fuse features to obtain a more complete 3D representation of the object. BEV features with different resolutions cannot be combined and reused between vehicles. For example, a high-resolution BEV grid vehicle would duplicate a low-resolution grid, which may not be desirable. No information on grid uncertainty would be provided to perform fusion. When reusing BEV grids from other vehicles, an ego-vehicle may combine information between BEV grids and thereby may lose information from higher resolution grids.

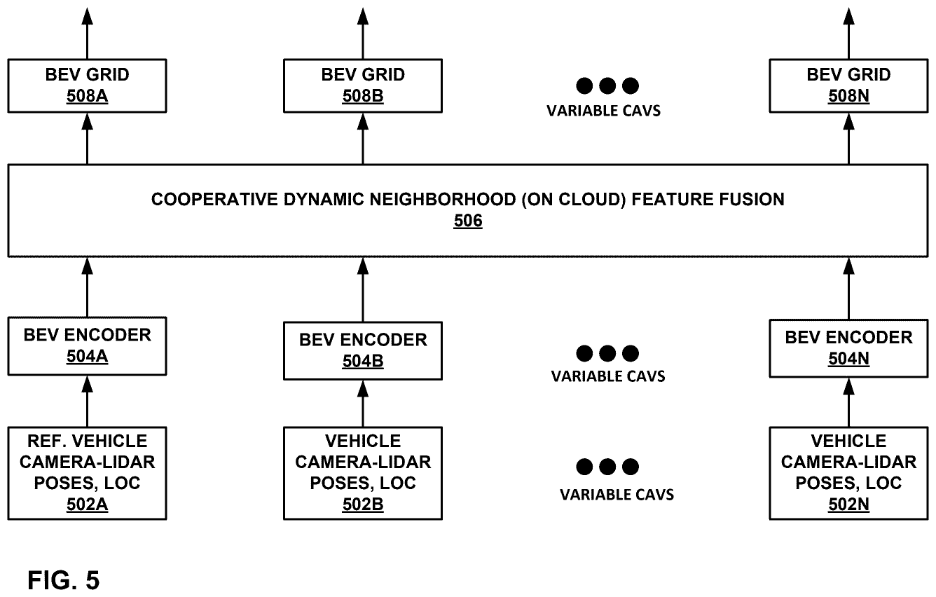

FIG. 5 is a block diagram of an example cooperative multi-vehicle dynamic BEV intermediate feature fusion architecture according to one or more aspects of this disclosure. In the example of FIG. 5, each vehicle, of a dynamic number of vehicles (1-N) may determine vehicle camera and LiDAR sensor poses. For example, a first vehicle (which may be a reference vehicle) may determine vehicle camera-LiDAR and location (e.g., via GPS sensor(s) of sensor(s) 108 (FIG. 1)) poses 502A, a second vehicle may determine vehicle camera-LiDAR and location poses 502B, and so on. An N-th vehicle may determine vehicle camera-LiDAR and location poses 502N. Each vehicle may determine poses of its own camera system, LiDAR system, and/or location.

Each of the vehicles may encode its own respective vehicle camera-LiDAR and location poses (502A-502N) using its own respective BEV encoder of BEV encoders 504A-504N.

Encoded vehicle camera-LiDAR and location poses for each of the vehicles may be obtained by a cloud-based computing system (e.g., one or more servers) which may perform cooperative dynamic neighborhood feature fusion 506, fusing the encoded vehicle camera-LiDAR and location poses. Each of the vehicles may then obtain from the cooperative dynamic neighborhood feature fusion 506 a respective fused BEV grid 508A-508N. These fused BEV grids 508A-508N may include higher-resolution data than the example of FIG. 4, where the resolution of the fused BEV grid may be, in areas of overlap of BEV grids 506A-506C, the lowest resolution of the overlapping BEV grids. This process may then be repeated, as any of the N vehicles may have moved and the poses of the camera, LiDAR, and/or location systems may have changed, as well as vehicle(s) may have left the group or additional vehicles may have been added to the group.

The example of FIG. 5 differs from the example of FIG. 4. For example, sensor data of each vehicle may be included in a BEV grid that is generated for any given vehicle without the given vehicle generating its own BEV grid based solely on its own sensor data prior to the generation of the BEV grid based on sensor data from multiple vehicles. In other words, each vehicle does not need to generate its own BEV grid solely based on its own sensor data. Additionally, the example of FIG. 5 may include a varying number of vehicles over the course of time and does not remain static (e.g., at 3 vehicles) as in the example of FIG. 4. As such, the amount of sensor data being used to generate the BEV grid may be dynamic and increase as a scene becomes more complex with additional vehicles entering the scene. While cooperative dynamic neighborhood feature fusion 506 is described as being cloud-based, in some examples, cooperative dynamic neighborhood feature fusion 506 may be based on the reference vehicle and/or another vehicle.

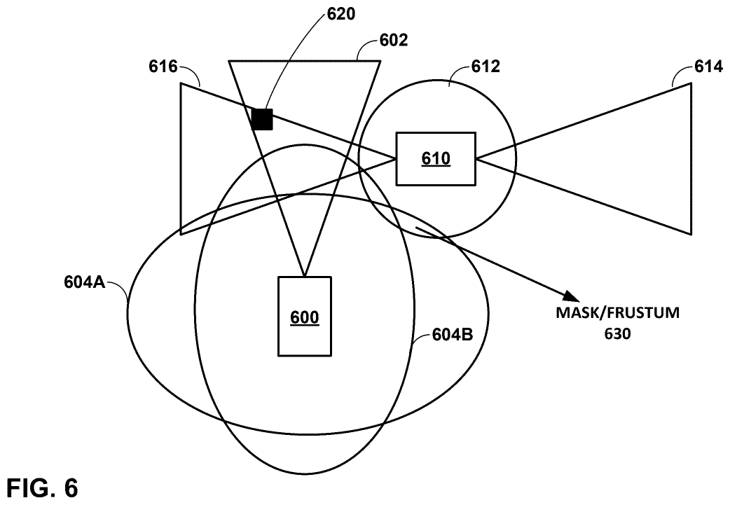

FIG. 6 is a conceptual diagram illustrating sensor data captured by two example vehicles according to one or more aspects of this disclosure. Vehicle 600 and vehicle 610 are depicted. Vehicle 600 may include a variety of sensors such as a plurality of fisheye cameras and a forward-facing camera. For example, four fisheye cameras have fields of view (FOV) 604A-604B and capture image data of FOVs 604A-604B. The forward-facing camera may have a FOV 602 and capture image data of FOV 602.

Vehicle 610 may have a LiDAR system, a forward-facing camera, and a rear-facing camera. The LiDAR system may have a FOV 612 that is 360 degrees around vehicle 610 and may capture point cloud data of FOV 612. The forward-facing camera may have a FOV 614 and may capture image data of FOV 614. The rear-facing camera may have a FOV 616 and may capture image data of FOV 616. As can be seen, FOVs of sensors of vehicle 600 overlap with each other, as do FOVs of sensors of vehicle 610. Additionally, some FOVs of sensors of vehicle 600 overlap with FOVs of sensors of vehicle 610.

Object 620 represents a dynamic (e.g., moving) object that may be sensed by vehicle 600 in FOV 602 and by vehicle 610 in FOV 616. With respect to vehicle 600, object 620 may be ahead of vehicle 600 at a certain distance and angle from a direction of travel of vehicle 600. With respect to vehicle 610, object 620 may be behind vehicle 610 at a different distance and angle from a direction of travel of vehicle 610. As object 620 is a dynamic object, and each of vehicles 600 and 610 may also be moving, the location, distance, and angle of object 620 from vehicle 600 and from vehicle 610 may change dramatically over time. A system of this disclosure may generate a mask/frustum 630 based on areas of overlap. Mask/frustum 630 may be used as part of composing fused BEV features as described later herein.

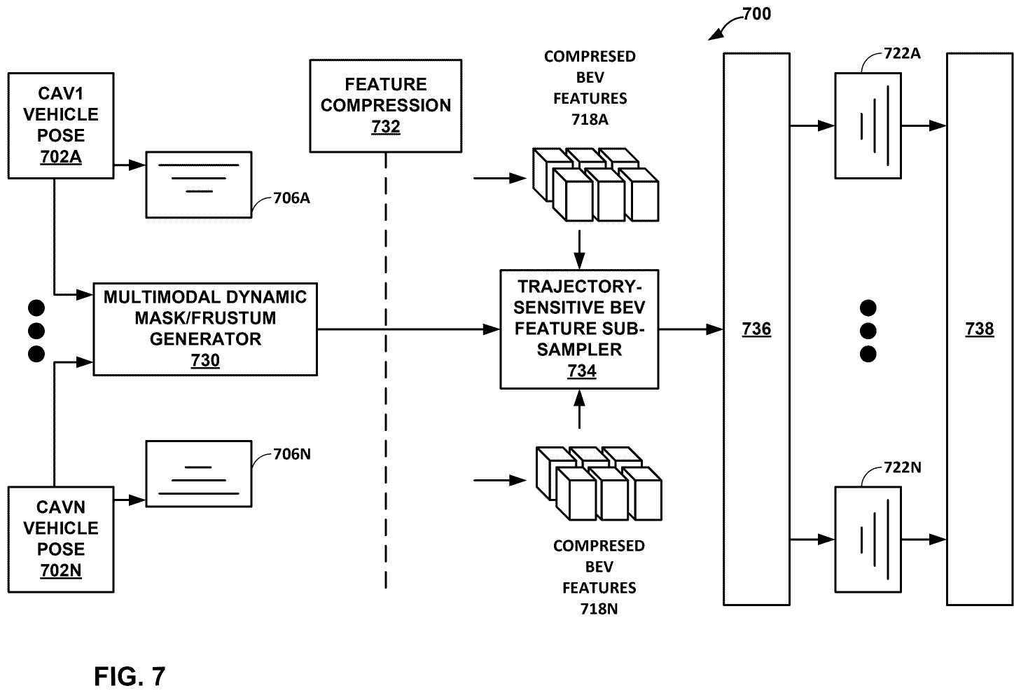

FIG. 7 is a block diagram illustrating an example architecture of a cooperative multi-vehicle dynamic BEV intermediate feature fusion system according to one or more aspects of this disclosure. The techniques of this disclosure include dynamic BEV intermediate feature fusion to address the issues of the above-described late feature fusion baseline discussed with respect to FIG. 4. System 700 may be implemented in one or more servers (e.g., in a cloud computing environment), one or more PSUs, and/or one or more vehicles.

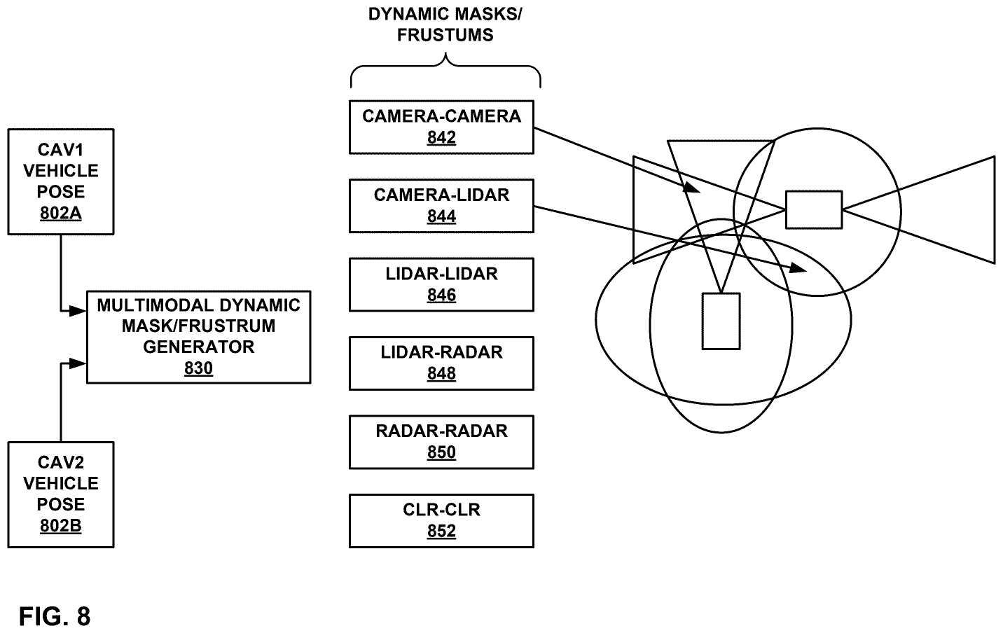

System 700 may obtain vehicle pose information from a plurality of vehicles. For example, system 700 may obtain CAV1 vehicle pose 702A through CAVN vehicle pose 702N (collectively “CAV vehicle poses 702”). Encoders 706A-706N may each encode information from corresponding CAVs, such as sensor system data, pose, and/or location data. In some examples, encoders 706A-706N may represent BEV encoders 504A-504N of FIG. 5, in which case encoders 706A-706N may be located in respective CAVs. Encoders 706A-706N and/or other encoders, such as flatten projection unit 314 and or PV-to-BEV projection unit 316 may be part of feature compression unit 732 which may generate compressed BEV features 718A-718N. Multi-modal dynamic mask/frustum generator 730 may generate a mask or frustum based on CAV vehicle poses 702. Multi-modal dynamic mask/frustum generator 730 is described in more detail with respect to FIG. 8.

Feature compression unit 732 may be utilized to address the issues of high communication overhead and potential delays, one possible solution is to use compressed versions of the raw BEV features. There are many ways to compress neural network feature vectors, and the best approach may depend on the specific use case and constraints. Potential ways to compress the BEV features include quantization, pruning, hashing, transform coding, or the like. In some examples, feature compression unit is part of multi-vehicle BEV unit 194 (FIG. 1). In some examples, feature compression unit is part of BEV unit 140 (FIG. 1).

Quantization involves reducing the number of bits used to represent each feature in the vector. For example, instead of using 32-bit floating point numbers, a system may use 8-bit integers to represent each feature. This reduces the storage required for each feature and can speed up computations by reducing memory access times. However, this can come at the cost of reduced accuracy.

Pruning involves removing some of the less important features from the vector. Pruning can be implemented by setting small weights to zero, or by using clustering algorithms to group similar features together. Pruning can reduce the storage required for the feature vector and can speed up computations by reducing the number of calculations required. However, this can also come at the cost of reduced accuracy.

Hashing involves mapping each feature in the vector to a fixed-length code using a hash function. This can reduce the storage required for the feature vector and can speed up computations by reducing memory access times. However, this can also come at the cost of data collisions, where different features are mapped to the same code, which can reduce accuracy.

Transform coding involves transforming the feature vector using a linear or non-linear transformation, such as the discrete cosine transform (DCT) or wavelet transform. The transformed coefficients may then be quantized and encoded using entropy coding techniques such as Huffman coding. This can reduce the storage required for the feature vector and can provide good compression performance. However, this technique can be computationally expensive and may require more storage than the other techniques described.

In some examples, feature compression unit 732 may apply one or more of these techniques, including any combination (e.g., two or more) of these techniques to generate compressed BEV features 718A-718N. By utilizing feature compression unit 732, system 700 may achieve a desired balance between compression performance and a level of accuracy.

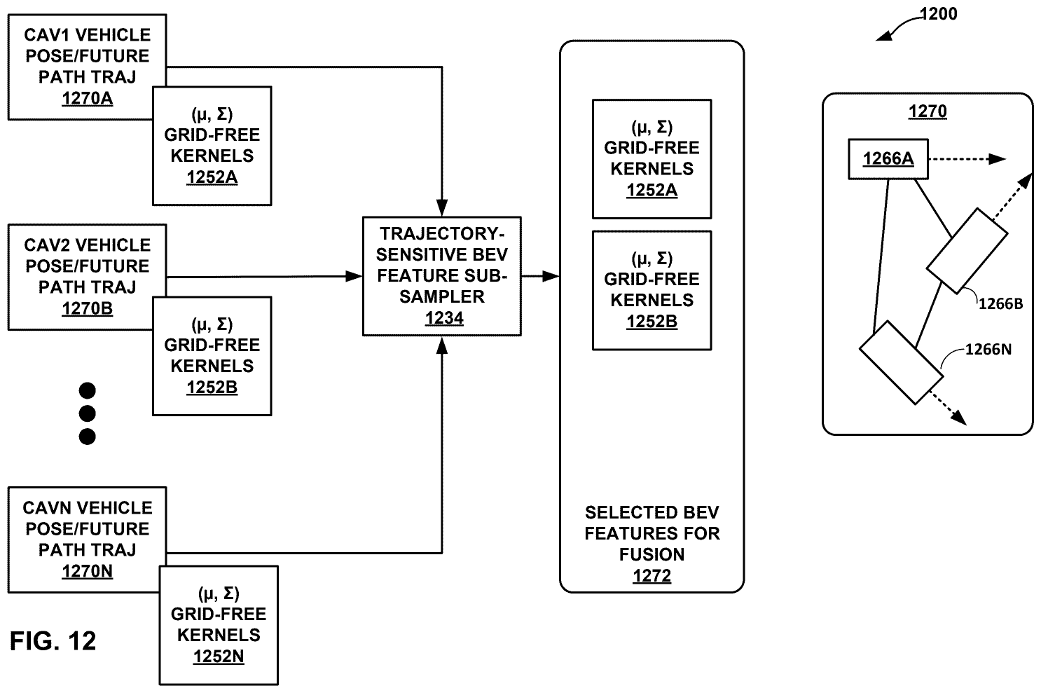

Trajectory-sensitive BEV feature sub-sampler 734 may sub-sample compressed BEV features 718A-718N utilizing one or more masks or frustums (e.g., mask/frustum 630 of FIG. 6). For example, because there may be bandwidth constraints in system 700, sub-sampling may be desirable. Trajectory-sensitive BEV feature sub-sampler 734 may sub-sample compressed BEV features 718A-718N based on a respective trajectory of vehicles CAV1-CAVN. The functioning of a trajectory-sensitive BEV feature sub-sampler is discussed in more detail with respect to FIG. 12.

The output of trajectory-sensitive BEV feature sub-sampler 734 may be obtained by vehicle radial dynamic neighborhood radial fusion feature fusion and BEV grid dispatcher hard/soft parameter sharing unit 736. In some examples, vehicle radial dynamic neighborhood radial fusion feature fusion and BEV grid dispatcher hard/soft parameter sharing unit 736 may align grids associated with some or all of the CAVs, for example, across a special Euclidean group 3 (SE3) transformation group, even if all CAVs have the same BEV grid size and resolution.

The output of vehicle radial dynamic neighborhood radial fusion feature fusion and BEV grid dispatcher hard/soft parameter sharing unit 736 may be provided back to the CAVs. Static 3D on-device fusion decoder 722A, which may be a static 3D on-device camera/LiDAR fusion decoder, for example, of CAV1, may decode the output of vehicle radial dynamic neighborhood radial fusion feature fusion and BEV grid dispatcher hard/soft parameter sharing unit 736. Similarly, static 3D on-device fusion decoder 722N, which may be a static 3D on-device camera/LiDAR fusion decoder, for example, of CAVN, may decode the output of vehicle radial dynamic neighborhood radial fusion feature fusion and BEV grid dispatcher hard/soft parameter sharing unit 736. Static 3D on-device fusion decoders 722A-722N may thereby generate a unified BEV grid 738.

FIG. 8 is a conceptual diagram illustrating a multi-modal dynamic mask/frustum generator according to one or more aspects of this disclosure. For example, multi-modal dynamic mask/frustum generator 830 (which may be an example of multi-modal dynamic mask/frustum generator 730 of FIG. 7) may be configured to generate dynamic masks and/or frustums based on overlapping areas represented in CAV1 vehicle pose 802A and CAV2 vehicle pose 802B. For example, in the example of FIG. 6, two vehicles were depicted with overlapping sensor FOVs. For example, multi-modal dynamic mask/frustum generator 830 may generate a dynamic mask/frustum camera-camera 842, which may represent an overlapping area of FOVs of cameras, such as the overlapping area of FOV 602 and FOV 616 of FIG. 6. Multi-modal dynamic mask/frustum generator 830 may generate a dynamic mask/frustum camera-lidar 844 which may represent an overlapping area of FOVs of a camera and a LiDAR system, such as the overlapping area of FOV of 604A and FOV 612. Other examples of dynamic masks/frustums that may be generated by multi-modal dynamic mask/frustum generator 830 include LiDAR-LiDAR 846 which may represent an area of overlapping FOVs of different LiDAR systems, LiDAR-radar 848 which may represent an area of overlapping FOVs of a LiDAR system and a radar system, radar-radar 850 which may represent an area of overlapping FOVs of different radar systems, camera-LiDAR-radar (CLR)-CLR 852 which may represent an area of overlapping FOV of different camera, LiDAR, and radar systems, or the like. It should be understood that multi-modal dynamic mask/frustum generator 830 may generate a dynamic mask/frustum for overlapping FOVs for any combination of different sensor systems, including overlapping FOVs of more than two sensor systems and/or of sensor systems of more than two vehicles.

These dynamic masks/frustums may be sent to a downstream dynamic BEV fusion unit (not shown in FIG. 8) that composes these features using any of a variety of techniques (e.g., channel, max, or self-attention-based techniques). The dynamic masks/frustums may be used to dynamically inform the downstream dynamic BEV fusion unit which combination(s) of sensors have overlapping FOVs based on the relative position of the CAVs. Because the FOV overlaps change over time, the input number of features may be dynamic. The downstream dynamic BEV fusion unit may fuse the features based on the dynamic masks/frustums. For example, if the FOVs of two cameras are overlapping, the downstream dynamic BEV fusion unit may use better BEV features to account for scale, and if the FOVs of two LiDAR systems were overlapping, the downstream dynamic BEV fusion unit may use a better BEV grid resolution to aggregate BEV features, etc.).

These dynamic masks/frustums may also provide camera-camera masks (e.g., dynamic mask/frustum camera-camera 842) where distortion in FOV of a camera could be different in different vehicles/cameras for a common object. This permits a better fusion of features across cameras using distance and angular distance from a principal point (e.g., a direction of travel, camera focal point, etc.) as inputs to the feature fusion process.

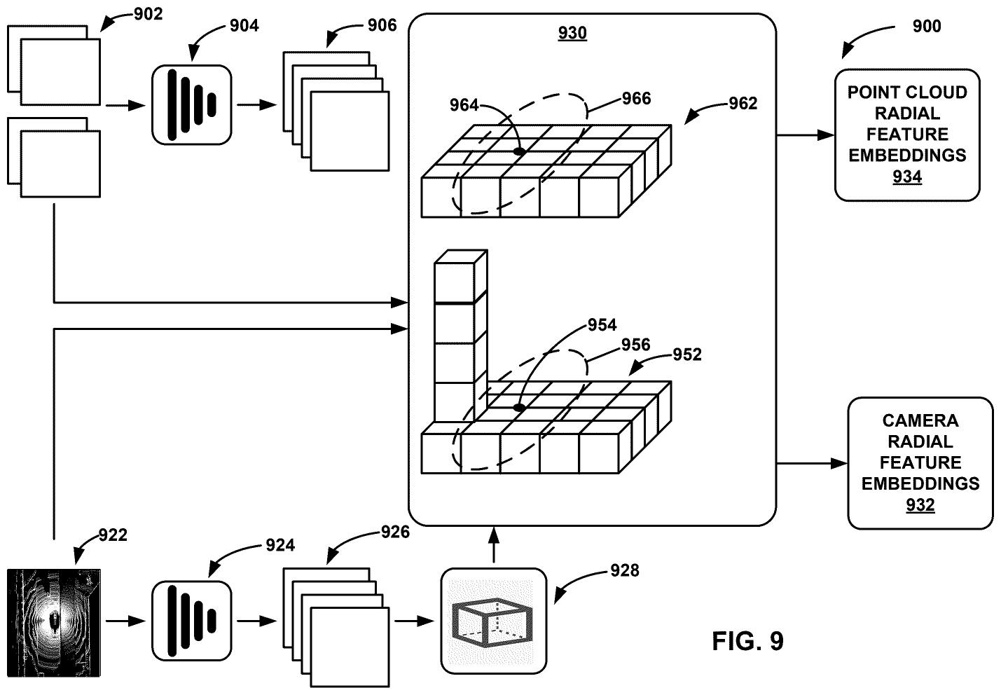

FIG. 9 is a block diagram illustrating a second encoder-decoder architecture 900 for processing image data and position data in a continuous space to generate an output, in accordance with one to more techniques of this disclosure. In some examples, second encoder-decoder architecture 900 may be a part of BEV unit 140 and/or multi-vehicle BEV unit 194 of FIG. 1. FIG. 9 illustrates 2D camera images 902, first feature extractor 904, perspective view features 906, 3D point cloud frames 922, second feature extractor 924, 3D features 926, and flattening unit 928. FIG. 9 also illustrates ray-to-BEV unit 930, camera radial feature embeddings 932, and point cloud radial feature embeddings 934. 2D camera images 902 may be examples of 2D camera images 168 of FIG. 1. In some examples, 2D camera images 902 may represent a set of camera images from 2D camera images 168 and 2D camera images 168 may include one or more camera images that are not present in 2D camera images 902. In some examples, 2D camera images 902 may be received from a plurality of cameras at different locations and/or different fields of view, which may be overlapping. In some examples, second encoder-decoder architecture 900 processes 2D camera images 902 in real time or near real time so that as camera(s) 104 captures 2D camera images 902, second encoder-decoder architecture 900 processes the captured camera images. In some examples, 2D camera images 902 may represent one or more perspective views of one or more objects within a 3D space where processing system 100 is located. That is, the one or more perspective views may represent views from the perspective of processing system 100.

In some examples, second encoder-decoder architecture 900 may be configured to convert the set of 2D camera images 902 into a first 3D representation of a 3D environment corresponding to 2D camera images 902 and 3D point cloud frames 922. 3D point cloud frames 922 may represent a second 3D representation of the 3D environment. In this way, second encoder-decoder architecture 900 may cause both 2D camera images 902 and the 3D point cloud frames 922 to be a 3D representation of the 3D environment. This may allow second encoder-decoder architecture 900 to process features extracted from 2D camera images 902 and the 3D point cloud frames 922 in a continuous space without using discrete processing that relies on 2D grids of features. For example, second encoder-decoder architecture 900 may generate a set of BEV features. Although the set of BEV features may include a 2D representation of the 3D environment, the set of BEV features might not rely on a 2D grid of BEV feature cells that place features corresponding to many different objects in the same cell.

First feature extractor 904 may represent an encoder of a neural network or another kind of model that is configured to extract information from input data and process the extracted information to generate an output. In some examples, the first feature extractor 904 represents a CNN, another kind of ANN, or another kind of model that includes one or more layers and/or nodes. Each layer of the one or more layers may include one or more nodes. Examples of layers include input layers, output layers, and hidden layers between the input layers and the output layers. A CNN, for example, may include one or more convolutional layers comprising convolutional filters. Each convolutional filter may perform one or more mathematical operations on the input data to detect one or more features such as edges, shapes, textures, or objects. CNNs may additionally or alternatively include activation functions that identify complex relationships between elements of an image and pooling layers that recognize patterns regardless of location within the image frame.

First feature extractor 904 may extract, from 2D camera images 902, perspective view features 906. Perspective view features 906 may provide information corresponding to one or more objects depicted in 2D camera images 902 from the perspective of camera(s) 104 which captures 2D camera images 902. For example, perspective view features 906 may include vanishing points and vanishing lines that indicate a point at which parallel lines converge or disappear, a direction of dominant lines, a structure or orientation of objects, or any combination thereof. Perspective view features 906 may include color information. Additionally, or alternatively, perspective view features 906 may include key points that are matched across a group of two or more camera images of 2D camera images 902. Key points may allow second encoder-decoder architecture 900 to determine one or more characteristics of motion and pose of objects. Perspective view features 906 may include any one or combination of image features that indicate characteristics of 2D camera images 902.

In some examples, perspective view features 906 may represent 2D features. That is, perspective view features 906 may indicate characteristics of one or more objects within the 3D environment corresponding to 2D camera images 902 and 3D point cloud frames 922 corresponding to locations on a 2D camera image from a perspective of camera(s) 104. One technique for converting perspective view features 906 into BEV features is to project perspective view features 906 onto a 2D grid of BEV cells. This may involve discrete processing that places features corresponding to many different objects into the same cell, which causes blurring and poor resolution. Second encoder-decoder architecture 900 may convert the perspective view features 906 into a 3D representation of the 3D environment so that encoder-decoder architecture 900 is configured to use continuous processing to generate BEV features instead of using discrete processing.

3D point cloud frames 922 may be examples of 3D point cloud frames 166 of FIG. 1. In some examples, 3D point cloud frames 922 may represent a set of 3D point cloud frames from 3D point cloud frames 166 and 3D point cloud frames 166 may include one or more 3D point cloud frames that are not present in 3D point cloud frames 922. In some examples, second encoder-decoder architecture 900 processes 3D point cloud frames 922 in real time or near real time so that as LiDAR system 102 generates 3D point cloud frames 922, second encoder-decoder architecture 900 processes the captured 3D point cloud frames. In some examples, 3D point cloud frames 922 may represent collections of point coordinates within a 3D space (e.g., x, y, z coordinates within a Cartesian space) where LiDAR system 102 is located. Since LiDAR system 102 is configured to emit light signals and receive light signals reflected off surfaces of one or more objects, the collections of point coordinates may indicate a shape and a location of surfaces of the one or more objects within the 3D space.

Second feature extractor 924 may represent an encoder of a neural network or another kind of model that is configured to extract information from input data and process the extracted information to generate an output. Second feature extractor 924 may be similar to first feature extractor 904 in that both the first feature extractor 904 and the second feature extractor 924 are configured to process input data to generate output features. But in some examples, first feature extractor 904 is configured to process 2D input data and second feature extractor 924 is configured to process 3D input data. In some examples, processing system 100 is configured to train first feature extractor 904 using a set of training data of training data 170 that includes one or more training camera images and processing system 100 is configured to train second feature extractor 924 using a set of training data of training data 170 that includes one or more point cloud frames. That is, processing system 100 may train first feature extractor 904 to recognize one or more patterns in camera images that correspond to certain camera image perspective view features and processing system 100 may train second feature extractor 924 to recognize one or more patterns in point cloud frames that correspond to certain 3D sparse features. In some examples, processing circuitry separate from processing system 100 is configured to train one or more elements of second encoder-decoder architecture 900 using training data stored separately from processing system 100.

Second feature extractor 924 may generate a set of 3D features 926 based on 3D point cloud frames 922. 3D features 926 may provide information corresponding to one or more objects indicated by 3D point cloud frames 922 within a 3D space that includes LiDAR system 102 which captures 3D point cloud frames 922. 3D features 926 may include key points within 3D point cloud frames 922 that indicate unique characteristics of the one or more objects. For example, key points may include corners, straight edges, curved edges, peaks of curved edges. Second encoder-decoder architecture 900 may recognize one or more objects based on key points. 3D features 926 may additionally or alternatively include descriptors that allow second feature extractor 924 to compare and track key points across groups of two or more point cloud frames of 3D point cloud frames 922. Other kinds of 3D features 926 include voxels and super pixels.

Flattening unit 928 may transform 3D features 926 into 2D features. Since 3D point cloud frames 922 represent multi-dimensional arrays of cartesian coordinates, flattening unit 928 may transform 3D features 926 into 2D features by compressing one of the dimensions of the x, y, z cartesian space into a flattened plane without compressing the other two dimensions. That is, the points within a column of points parallel to one of the dimensions of the x, y, z cartesian space may be compressed into a single point on a 2D space formed by the two dimensions that are not compressed. Perspective view features 906 extracted from 2D camera images 902, on the other hand, might not include cartesian coordinates. This means that it may be beneficial to transform perspective view features 906 into a 3D representation of the 3D environment so that both of features extracted from image data and features extracted from position data can be processed in a continuous space without using discrete processing that relies on 2D grids of BEV cells.

Ray-to-BEV unit 930 may receive perspective view features 906 extracted from 2D camera images 902. Ray-to-BEV unit 930 may receive the output from flattening unit 928 which represents flattened 3D features 926 extracted from 3D point cloud frames 922. Ray-to-BEV unit 930 may receive 2D camera images 902 and 3D point cloud frames 922. Based on any one or combination of perspective view features 906, the output from flattening unit 928, 2D camera images 902, and 3D point cloud frames 922, ray-to-BEV unit 930 may generate camera radial feature embeddings 932 and point cloud radial feature embeddings 934.

In some examples, ray-to-BEV unit 930 may generate camera radial feature embeddings 932 by converting perspective view features 906 and 2D camera images 902 into a 3D representation of the 3D environment corresponding to 2D camera images 902 and 3D point cloud frames 922. For example, ray-to-BEV unit 930 may create, based on each camera image pixel of 2D camera images 902, a ray through a 3D space. Ray-to-BEV unit 930 may identify, for the ray corresponding to each camera image pixel of 2D camera images 902, one or more points within the 3D space. Ray-to-BEV unit 930 may create, for the one or more points of each ray corresponding to 2D camera images 902, a depth distribution. Ray-to-BEV unit 930 may generate a 3D feature volume based on the 3D space and the depth distribution of each ray corresponding to 2D camera images 902. The 3D feature volume may represent a 3D representation of the 3D environment corresponding to 2D camera images 902 and 3D point cloud frames 922. In some examples, ray-to-BEV unit 930 may generate point cloud radial feature embeddings 934 based on 3D point cloud frames 922 and 3D features 926 extracted from 3D point cloud frames 922.

Ray-to-BEV unit 930 may be configured to generate camera radial feature embeddings 932 and point cloud radial feature embeddings 934. Ray-to-BEV unit 930 includes first 3D space 952, a first reference point 954, a first spatial neighborhood 956, a second 3D space 962, a second reference point 964, and a second spatial neighborhood 966.

Ray-to-BEV unit 930 may build kernelized continuous representation of feature maps in a BEV space by using a splatting point cloud representation from camera pixel-ray context representation in local self similarity (LSS). To generate precise depth-to-center feature embeddings, ray-to-BEV unit 930 may use a 3D reference point from LiDAR point clouds and examine a spherical neighborhood around the reference point to learn a multivariate Gaussian mixture with mean/covariance estimates. Perspective view features regions corresponding to the 3D reference point and their respective rays may be used to evaluate variational autoencoder (VAE) parameters and/or GMM parameters.

Ray-to-BEV unit 930 may generate first 3D space 952 based on 2D camera images 902. In some examples, ray-to-BEV unit 930 may generate first 3D space 952 by generating a ray corresponding to each pixel of 2D camera images 902. The ray corresponding to each pixel of 2D camera images 902 may include a set of points. In some examples, ray-to-BEV unit 930 may generate camera radial feature embeddings 932. By generating the first 3D space 952 based on 2D camera images 902, ray-to-BEV unit 930 may convert 2D camera images 902 into a 3D representation of the 3D environment corresponding to 2D camera images 902 and 3D point cloud frames 922. Converting 2D camera images 902 into the 3D representation of the 3D environment may allow ray-to-BEV unit 930 to generate camera radial feature embeddings 932 in a way that does not rely on fixed grids of BEV features.

Ray-to-BEV unit 930 may, in some examples, generate camera radial feature embeddings 932 by populating the first 3D space with perspective view features of perspective view features 906. For example, ray-to-BEV unit 930 may select first reference point 954 based on 3D point cloud frames 922 and populate first spatial neighborhood 956 with perspective view features of perspective view features 906 corresponding to the first reference point 954. In some examples, first reference point 954 may be one reference point of a set of reference points corresponding to first 3D space 952. Ray-to-BEV unit 930 may populate a spatial neighborhood corresponding to each reference point with perspective view features in the spatial neighborhood of the reference point.

In some examples, second 3D space 962 corresponds to a 3D space of 3D point cloud frames 922. Since 3D point cloud frames 922 includes points having 3D coordinates, 3D point cloud frames 922 may already represent a 3D space without needing conversion to 3D. Ray-to-BEV unit 930 may populate second 3D space 962 with 3D features of 3D features 926. For example, ray-to-BEV unit 930 may select second reference point 964 based on 3D point cloud frames 922 and populate second spatial neighborhood 966 with 3D features of 3D features 926 corresponding to second spatial neighborhood 966. In some examples, second reference point 964 represents one reference point of a set of reference points corresponding to second 3D space 962. Ray-to-BEV unit 930 may populate a spatial neighborhood corresponding to each reference point with respective 3D features of 3D features 926.

Ray-to-BEV unit 930 may use radial neighborhood feature selection to generate camera radial feature embeddings 932 and point cloud radial feature embeddings 934. Camera BEV features may be “splatted” onto a point cloud, transformed using a neighbor centered on a LiDAR point cloud. BEV features may be continuously embedded using VAE GMMs. Ray-to-BEV unit 930 may convert the point cloud representation from camera perspective features into BEV features. More information on radial feature embeddings may be found in U.S. patent application Ser. No. 18/466,460, filed on Sep. 13, 2023, the entire content of which is incorporated herein by reference. It should be noted that obtained BEV radial feature embeddings are not limited to point cloud radial feature embeddings or camera radial feature embeddings, but may include radial feature embeddings for other sensor systems, such as radar or the like.

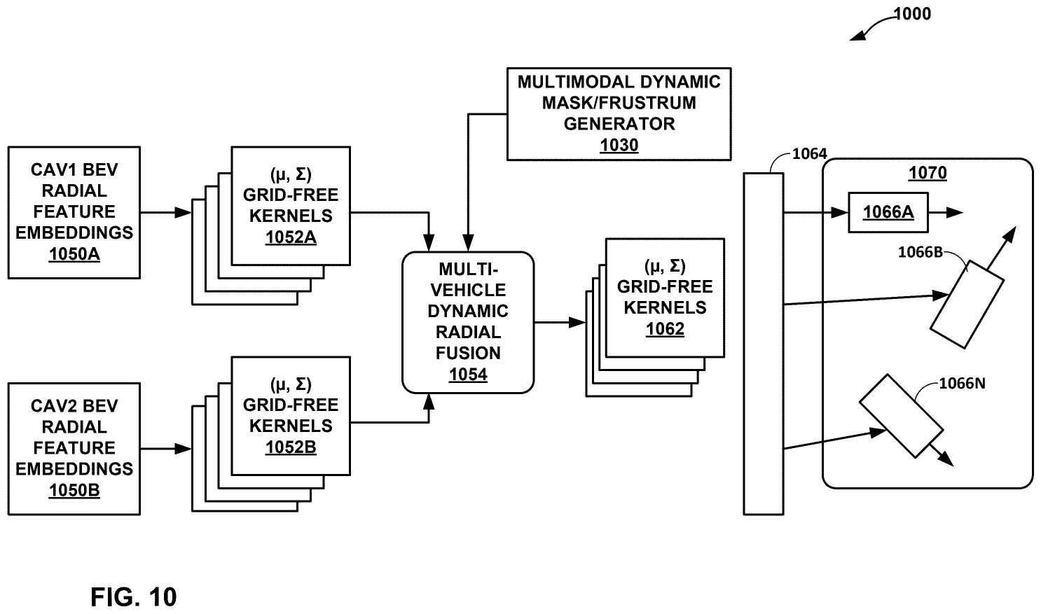

FIG. 10 is a block diagram illustrating example vehicle radial neighborhood embedding system according to one or more aspects of this disclosure. System 1000 may determine or otherwise obtain BEV radial feature embeddings, such as point cloud radial feature embeddings 934 and camera radial feature embeddings 932 for a plurality of vehicles. System 1000 may be implemented in one or more servers (e.g., in a cloud computing environment), one or more PSUs, and/or one or more vehicles.

For example, system 1000 may obtain CAV1 BEV radial feature embeddings 1050A and CAV2 BEV radial feature embeddings 1050B. System 1000 may generate grid-free kernels 1052A based on CAV1 BEV radial feature embeddings 1050A and generate grid-free kernels 1052B based on CAV2 BEV radial feature embeddings 1050B. For example, system 1000 may be configured to generate grid-free BEV feature kernels 1052A-1052B in a continuous space without relying on 2D grids of BEV features. Grid-free kernels 1052A-1052B may be variational autoencoder-Gaussian mixture model (VAE-GMM) kernels and each kernel may be per a vehicle BEV feature. VAE-GMM kernels may include a VAE component and a GMM component. The VAE component may map input data to a probabilistic distribution in a latent space and include data samples from points in the latent space. The GMM component may represent a mixture of multiple Gaussian distributions that may be used for clustering, density estimation, and generative modeling. In some examples, grid-free kernels 1052A-1052B may not include grid information associated with CAV1 and CAV2. For example, CAV1 BEV radial feature embeddings 1050A and/or CAV2 BEV radial feature embeddings 1050B may not include grid information. To the extent that CAV1 BEV radial feature embeddings 1050A and/or CAV2 BEV radial feature embeddings 1050B may include grid information, system 1000 may remove such grid information in generating grid-free kernels 1052A-1052B.

Grid-free kernels 1052A-1052B and any masks/frustums of multi-modal dynamic mask/frustum generator 1030 (which may be an example of multi-modal dynamic mask/frustum generator 830) may be input to multi-vehicle dynamic radial fusion unit 1054. Multi-vehicle dynamic radial fusion unit 1054 may include a dynamic BEV fusion unit or module that performs intermediate feature fusion to extend perception robustly, not only within an intersection of FOVs of sensors, but also across vehicles. Multi-vehicle dynamic radial fusion unit 1054 may function to fuse BEV features even when different vehicle and/or sensor systems do not output BEV grids in the same reference frame, orientation, and/or resolution. Multi-vehicle dynamic radial fusion unit 1054 may be implemented in a cloud computing environment, taking advantage of existing BEV encoders on each vehicle. Multi-vehicle dynamic radial fusion unit 1054 may include a neural network, such as a deep neural network, that is trained for fusion across sparse dynamic vehicle interactions.

Multi-vehicle dynamic radial fusion unit 1054 may fuse grid-free kernels 1052A and grid-free kernels 1052B to generate fused grid-free kernels 1062. Since both grid-free kernels 1052A and grid-free kernels 1052B do not rely on fixed grids of BEV features, multi-vehicle dynamic radial fusion unit 1054 may fuse grid-free kernels 1052A and grid-free kernels 1052B without relying on discrete processing.

System 1000 may use a GMM to fit grid-free kernels 1052A and grid-free kernels 1052B to continuous space 2D coordinates centered on reference points from 3D point cloud frames 166 of FIG. 1, for example, of a reference vehicle. Grid-free kernels 1052A and grid-free kernels 1052B may each represent continuous GMM features from a plurality of sensor systems.

Multi-vehicle dynamic radial fusion unit 1054 may combine grid-free kernels 1052A and grid-free kernels 1052B to generate grid-free kernels 1062 by estimating a unified grid-free representation by combining the GMM estimates via resampling. Ground truth discretization may be avoided by using kernelized continuous representation of segmentation by centering around a reference point in a 3D point cloud frame of 3D point cloud frames 166, for example, of a reference vehicle. The BEV features, ground truth, and BEV output prediction may thus be represented as a 2D BEV mixture model avoiding discretization artifacts.

Multi-vehicle dynamic radial fusion unit 1054 (which may be cloud-based) may process the input to generate grid-free kernels 1062. Grid-free kernels 1062 may be VAE-GMM kernels and each kernel may be per a vehicle BEV feature. BEV feature grid dispatch-discretizer 1064 may discretize grid-free kernels 1062 for each vehicle and send the discretized kernels to each of vehicle 1066A-1066N. For example, the discretized kernels may be represented as a CAV neighborhood dynamic graph 1070. BEV feature grid dispatch-discretizer 1064 allows for updating a reference vehicle's BEV grid with information from neighboring grids at a correct resolution for the reference vehicle.

System 1000 may perform a query radius based dynamic (e.g., variable in size due to a number of CAVs about a reference CAV being dynamic) feature fusion across vehicles using a kernelized BEV fusion technique. This fusion may be performed collaboratively across all interacting CAVs so that typically all CAVs gain from resulting improved perception and fused features. The radial embeddings also permit fusion when CAVs have differences in rotation, translation, and/or BEV grid resolution. The final fused results may be stored and maintained dynamically in a cloud computing environment, such as in a 5G cloud-based feature fusion network which may be separately implemented on the cloud. The final kernelized BEV features may be re-discretized and sent to a target vehicle in the target vehicle's reference (e.g., rotation/translation) and at the right or preferred BEV grid resolution for the target vehicle. For example, a preferred BEV grid resolution for the target vehicle may be based on the ego vehicle's sensors (e.g., range and/or resolution of such sensors (LIDAR, Camera, RADAR) and the incoming cloud-based BEV grid. For example, the highest resolution may be based on a composition of the two and not one or the other. In some examples, a preferred BEV grid resolution may not necessarily be a highest resolution possible. For example, a vehicle leaving a CAV neighborhood (e.g., of CAV neighborhood dynamic graph 1070), which may be unlikely to collide with other vehicles of the group, may not require as high resolution as a vehicle still within the group of CAVs or entering into the group of CAVs. As such, BEV feature grid dispatch-discretizer 1064 may adaptively transmit BEV features at different resolutions so as to reduce the bandwidth used to transmit BEV features.

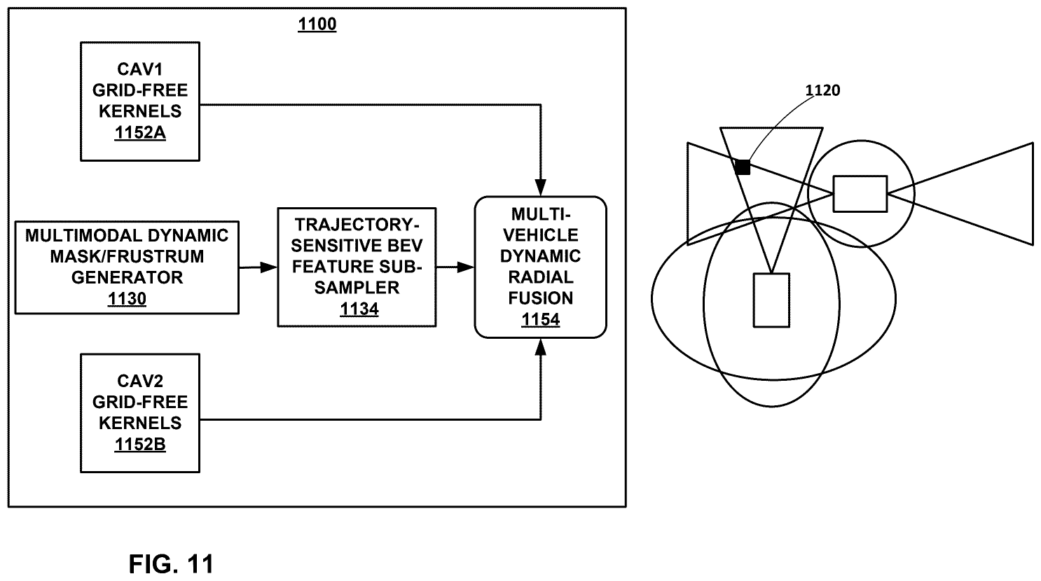

FIG. 11 is a block diagram illustrating an example dynamic multi-modal grid fusion system according to one or more aspects of this disclosure. In the example of FIG. 10, system 1100 may determine or otherwise obtain grid-free kernels such as CAV1 grid-free kernels 1152A (which may be an example of CAV1 grid-free kernels 1052A) and CAV2 grid-free kernels 1152B (which may be an example of CAV2 grid-free kernels 1052B). Multi-modal dynamic mask/frustum generator 1130 (which may be an example of multi-modal dynamic mask/frustum generator 730) may generate masks/frustums as discussed herein. Trajectory-sensitive BEV feature sub-sampler 1134 (which may be an example of trajectory-sensitive BEV feature sub-sampler 734) may sub-sample compressed BEV features using the masks/frustums as discussed above with respect to FIG. 7. In the example of FIG. 11, multi-vehicle dynamic radial fusion unit 1154 (which may be an example of multi-vehicle dynamic radial fusion unit 1054 of FIG. 10) may include a dynamic fusion layer and a cross-vehicle cross-camera dynamic object fusion with dynamic intra-CAV trajectory distance.

The dynamic fusion layer of multi-vehicle dynamic radial fusion unit 1154 may obtain as input a variable number of BEV grid features and may fuse such BEV grid features adaptively. This fusion layer uses dynamic masks generated by multi-modal dynamic mask/frustum generator 1130 showing camera-camera, camera-LiDAR, camera-LiDAR-radar, LiDAR-radar, LiDAR-LiDAR, radar-radar, and/or the like, interactions and correspondingly fuses the BEV grid features using sensor/sensor set based uncertainties. For example, each sensor/sensor set may have a corresponding uncertainty that may be different than another sensor/sensor set. For example, camera-camera may have one uncertainty, while camera-LiDAR may have another uncertainty that is different than the uncertainty of camera-camera. For example, sensor resolution of may affect BEV grid resolution and downstream fusion and as such, each sensor/sensor set may have its own corresponding uncertainty.

The cross-vehicle cross-camera dynamic object fusion with dynamic intra-CAV trajectory distance may operate as follows. Object 1120 (which may be an example of object 620 of FIG. 6) may become visible across different scales/distances and positions in camera viewpoints of two vehicles. If the CAVs move towards each other the relative variation in scale of object 1120 will remain roughly similar. However, if the CAVs move in a way to increase distance therebetween, object scales change in a relatively anticorrelated sense. As such, the cross-vehicle cross-camera dynamic object fusion with dynamic intra-CAV trajectory distance may combine features using relative trajectories between a reference and neighboring CAV vehicles. This gives the dynamic fusion layer better multiscale-features to extract the dynamic objects, such as object 1120.

FIG. 12 is a block diagram illustrating an example of trajectory-sensitive sub-sampling according to one or more aspects of this disclosure. System 1200 may determine or otherwise obtain various vehicle poses and future path trajectory information for a dynamic number of vehicles, for example, of CAV neighborhood dynamic graph 1270. System 1200 may also obtain or determine grid-free kernels 1252A-1252N, which may be examples of grid-free kernels 1052A or 1052B of FIG. 10 or grid-free kernels 1152A or 1152B of FIG. 11.

Trajectory-sensitive BEV feature sub-sampler 1234 (which may be an example of trajectory sensitive BEV feature sub-sampler 734) may sub-sample vehicle pose and future path trajectories to select a subset of grid-free kernels 1252A-1252N resulting in selected BEV features for fusion 1272. For example, selected BEV features for fusion 1272 may include grid-free kernels 1252A and grid-free kernels 1252B.

For example, vehicle interactions whose future trajectories within a given time interval do not interact for more than K-seconds may be not included in the selected BEV features for fusion 1272 and thus may be dropped from, or otherwise not included in, the neighborhood graph (e.g., CAV neighborhood dynamic graph 1270 with future path trajectories) which may be sent to vehicles 1266A-1266N. The time horizon in the future (the K-seconds) may be programmable or may be dynamic, for example, based on a velocity and/or direction of travel of one or more of the vehicles in a neighborhood. For example, as shown in CAV neighborhood dynamic graph 1270 with future path trajectories, there may be an imminent interaction between vehicle 1266A and vehicle 1266B, but no imminent interaction with between either vehicle 1266A or vehicle 1266B and vehicle 1266N. As such, system 1200 may drop features from vehicle 1266N and not include such features in selected BEV features for fusion 1272.

As discussed herein, the dynamic feature techniques of this disclosure may include the use of a multi-modal dynamic mask/frustum generator (e.g., multi-modal dynamic mask/frustum generator 730). Vehicle interactions are dynamic and may be limited within a neighborhood of fixed radius chosen by a cloud-based fusion module (e.g., external processing system 180). The multi-modal dynamic mask/frustum generator may obtain and evaluate BEV features from camera, LiDAR, radar and intersections thereof.

The dynamic feature techniques of this disclosure may include the use of vehicle pose and grid resolution adaptive fusion using kernelized BEVs. For example, kernelized BEV representations may be used to fuse grids at different translations, rotations, and/or orientations. Each vehicle may have a different BEV grid resolution, which refers to the size and granularity of the grid used to represent the region. These variations may be accounted for to ensure consistent and accurate fusion of BEV features. Kernelizing the BEV output provides a way to have a position sensitive embedding that is relatively easy to decode in a global BEV grid.

The dynamic feature fusion techniques of this disclosure may include dynamic feature fusion with variable FOV intersection areas. Dynamic feature fusions may be achieved using dynamic neural network architectures implemented on the cloud. This layer may use the uncertainties from single sensors and any combination of sensors to perform robust fusion. As the neural network is dynamic at inference time resulting inferences may be more accurate in a dynamic scene such as those of an autonomous driving scenario. In some examples, the dynamic neural network may learn over time as new vehicles having different sensor system setups connect to the cloud layer. The dynamic fusion is performed over grid-free radial embeddings which helps to combine grid features at different resolutions, thereby not losing resolution in the process.

The dynamic feature fusion techniques of this disclosure may include a BEV feature grid dispatch-discretizer (e.g., vehicle radial dynamic neighborhood radial fusion feature fusion and BEV grid dispatcher hard/soft parameter sharing unit 736 of FIG. 7 or BEV feature grid dispatch-discretizer 1064 of FIG. 10). The BEV feature grid dispatch-discretizer may dynamically maintain, in the cloud, final fused results, such as in a 5G cloud-based feature fusion network. For example, external processing system 180 may store the final fused results in memory 198 (FIG. 1). The BEV feature grid dispatch-discretizer may re-discretized features and send the re-discretized features to the target vehicle in its own reference (rotation/translation) at the right BEV grid resolution for the target vehicle.

The dynamic feature fusion techniques of this disclosure may include a trajectory sensitive sub-sampler (e.g., trajectory-sensitive BEV feature sub-sampler 1234) for bandwidth constraints. The trajectory sensitive sub-sampler may drop vehicles, or features from vehicles, whose future trajectories within a given time interval do not interact with other vehicles for more than K-seconds from the neighborhood graph and associated features may not be sent to vehicles from the cloud.

The techniques of this disclosure may also include feature compression. Each vehicle may obtain a common BEV feature vector of a preconfigured size using images obtained from one or more of its vehicle cameras. Irrespective of the number of cameras/LiDAR/radar that each vehicle has (e.g., which may be different for each vehicle), the BEV features sent by the vehicles may have a same size. This will enable the cloud to perform global BEV inference on heterogenous vehicles. In one case, the BEV feature vector size is specified by camera-to-camera (C2C) during the initial connection set up.

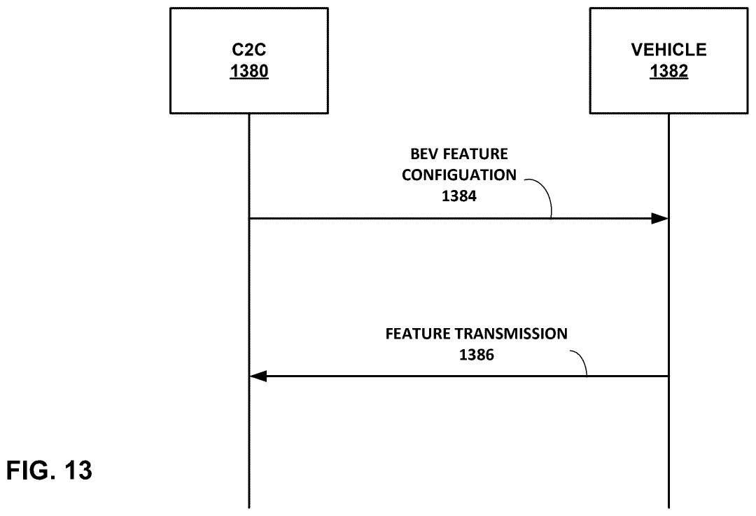

For example, a vehicle obtains BEV features corresponding to images and point clouds from each of the camera and LiDAR systems of the vehicle. A first vehicle with N cameras uses a first multilayer perception (MLP) feature normalization network, while a second vehicle with M cameras uses a second MLP feature normalization network to obtain BEV feature vectors of identical preconfigured BEV feature vector sizes. The output of MLP feature normalization denotes the raw BEV feature R that is transmitted. To minimize communication overhead, C2C provides the model for the MLP compression encoder. In the event that a vehicle uses a compression encoder, C2C may provide the index of encoder used for obtaining the compressed feature (details below). Signaling between C2C and vehicle is described with respect to FIG. 13.

FIG. 13 is a flow diagram illustrating an example communication between a C2C server and a vehicle. The following signaling details provide information about the communication between a C2C server 1380 and vehicle(s) 1382, specifically regarding the BEV feature vector. The details are broken down into two parts: the information sent from the C2C server to the vehicle, and the information sent from the vehicle to the C2C server. While referred to as a server, it should be understood that C2C server 1380 may include one or more servers.

For example, C2C server 1380 may send to vehicle(s) 1382 BEV feature configuration information 1384 which may include any of, or any combination of, the following described information. BEV feature configuration information 1384 may include BEV feature size, {xhxw: which specifies the size of the BEV feature vector that vehicle 1382 should transmit to C2C server 1380. BEV feature configuration information 1384 may include a model index, such as a multilayer perceptron (MLP) model index, or the model itself of the 2D-to-BEV transformation. This information specifies the MLP model or the index of the MLP model that vehicle 1382 should use to transform its 2D camera images into BEV feature vectors. BEV feature configuration information 1384 may include MLP model or the model indexes for BEV feature compression. This information specifies the MLP model or the index of the MLP model that vehicle 1382 should use to compress the BEV feature vector before transmitting the BEV feature vector to C2C server 1380. In some examples, the MLP model may be a model a vehicle uses as a BEV encoder (e.g., of BEV encoders 604 of FIG. 5).

Vehicle 1382 may transmit feature transmission 1386. Feature transmission 1386 may include any of, or any combination of, the following information. Feature transmission 1386 may include BEV feature of size (xhxw: This is the raw BEV feature vector that vehicle 1386 has obtained from its camera images. Feature transmission 1386 may include a bit or a flag indicating whether the BEV feature is compressed or not. For example, the flag may indicate whether the BEV feature vector has been compressed or not. If the BEV feature vector is compressed, vehicle 1382 may also send the index of the MLP compression encoder that was used to compress the BEV feature vector. Feature transmission 1386 may include an index indicating the MLP index used for feature compression. For example, this may be the index of the MLP compression encoder that was used to compress the BEV feature vector, if the BEV feature vector is compressed.

Transmitting raw BEV features as a dedicated message or part of existing messages from vehicle 1382 to C2C server 1380 can be a simple and straightforward approach. However, this could lead to higher communication overhead and potential delays in message delivery. Moreover, the raw BEV features may not be easily usable by other vehicles or the cloud without additional processing.

In some examples, vehicle 1382 may perform feature compression as described with respect to feature compression unit 732 above, rather than, or in addition to, feature compression unit 732.

In some examples, vehicle 1382 may transmit soft or hard BEV features instead of raw BEV features. Soft BEV features are probabilities or likelihoods of object presence or object attributes, while hard BEV features are binary or categorical representations of object presence or attributes. By transmitting soft or hard BEV features, rather than raw BEV features, the amount of data that needs to be transmitted may be reduced, leading to lower communication overhead. Moreover, soft or hard BEV features may be more easily processed and integrated into existing sensor fusion algorithms. Finally, to further reduce communication overhead, only BEV features of specified objects or regions of interest (ROI) may be transmitted. This enables the cloud or the receiving vehicle to enhance alignment accuracy, leading to better BEV accuracy. Additionally, the cloud can request BEV features of ROIs or objects from a first vehicle, based on BEV inference obtained from a second or third vehicle, which further reduces communication overhead.

The concept of hard BEV features is to indicate the presence of objects in the local BEV grid as perceived by the vehicle. When transmitting hard BEV features, the information transmitted may include the center coordinates and dimensions of each object. By transmitting only this information, the communication overhead may be drastically minimized. For example, if there are two objects in the local BEV grid as perceived by the vehicle, the vehicle may report the hard BEV features for each object as follows:
Object 1: Center coordinates (x_1,y_1), and dimensions l_1×w_1
Object 2: Center coordinates (x_2,y_2), and dimensions l_2×w_2.
   In addition to the signaling details, C2C 1380 (e.g., as part of BEV feature configuration information 1384) may provide vehicle 1382 with the BEV grid size on which vehicle 1382 is to report the hard features. This ensures that the hard features are consistent across all vehicles and can be processed uniformly. It is worth noting that in some cases, the object center and dimensions may be normalized to the signaled BEV grid size. This means that the center and dimensions may be scaled to fit within the BEV grid size provided by C2C 1380.

Soft BEV features are probabilistic measures of the likelihood of object presence or object attributes in the local BEV grid as perceived by the vehicle. These features may be represented as a probability distribution over the object classes and attributes and may be obtained using various machine learning models, such as object detectors, trackers, and/or classifiers. For example, vehicle 1382 may use an object detection model to detect objects in its local field of view and generate soft BEV features for each detected object. These features may represent the probability or likelihood of the detected object belonging to a particular class (e.g., car, pedestrian, bicycle) and having certain attributes (e.g., size, orientation, velocity).

The soft BEV features may also be used to estimate the uncertainty associated with object detection, as well as to refine the object detection output from the vehicle's local BEV grid. For example, C2C server 1380 may fuse the soft BEV features from multiple vehicles to generate a more accurate and reliable global BEV map. Overall, soft BEV features may provide a richer representation of the local BEV grid than hard BEV features, as they capture the uncertainty and variability associated with object detection, tracking, and/or classification. This enables more robust and accurate perception of the environment and enhances the performance of downstream tasks such as motion planning and control.

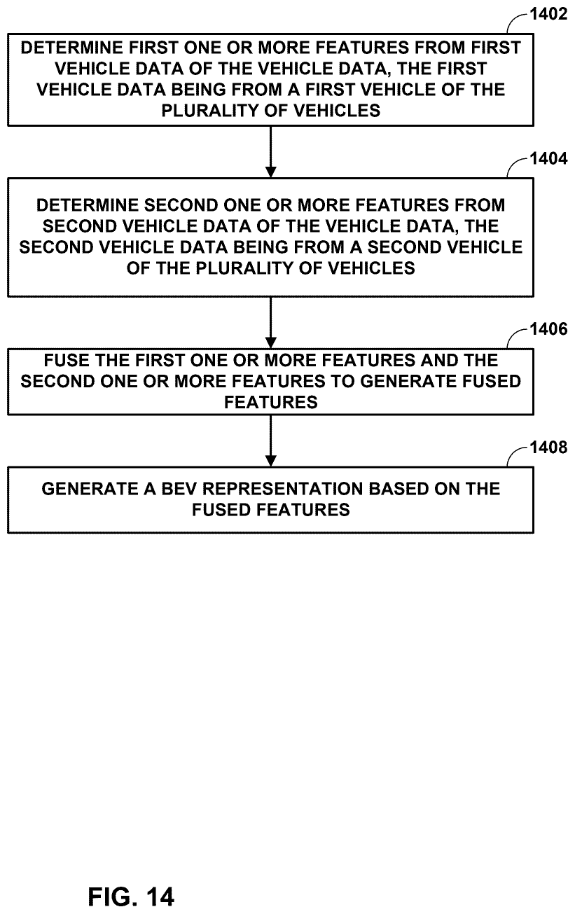

FIG. 14 is a flow diagram illustrating example multi-vehicle BEV feature fusion techniques according to one or more aspects of this disclosure. The multi-vehicle BEV feature fusion techniques of FIG. 14 may be implemented in in one or more servers, one or more RSUs, and/or one or more vehicles. External processing system 180 or processing system 100 may obtain vehicle data. For example, external processing system 180 or processing system 100 may receive from each of a plurality of vehicles, pose, trajectory, location, BEV features, grid-free kernels, and/or other information. In some examples, the received vehicle data may include grid-free data. In some examples, received vehicle data may not include grid-free data.

External processing system 180 or processing system 100 may determine one or more first features from first vehicle data of the vehicle data, the first vehicle data being from a first vehicle of the plurality of vehicles (1402). For example, external processing system 180 or processing system 100 may determine features in the first vehicle data based on grid-free kernels 1052A. External processing system 180 or processing system 100 may determine one or more second features from second vehicle data of the vehicle data, the second vehicle data being from a second vehicle of the plurality of vehicle (1404). For example, external processing system 180 or processing system 100 may determine features in the second vehicle data based on grid-free kernels 1052B.

External processing system 180 or processing system 100 may fuse the one or more first features and the one or more second features to generate fused features (1406). For example, external processing system 180 or processing system 100 may fuse grid-free kernels 1052A and grid-free kernels 1052B to generate grid-free kernels 1062.

External processing system 180 or processing system 100 may generate a BEV representation based on the fused features (1408). For example, external processing system 180 or processing system 100 may generate CAV neighborhood dynamic graph 1070, which may be a BEV representation.

In some examples, external processing system 180 or processing system 100 may send the BEV representation to at least one vehicle of the plurality of vehicles. For example, external processing system 180 or processing system 100 may send CAV neighborhood dynamic graph 1070 to vehicle 1066A, vehicle 1066B, and/or vehicle 1066N.

In some examples, at least one processor of the one or more processors that is configured to generate the BEV representation is located in the first vehicle or the second vehicle. For example, at least one processor of processing system 100 (on the first vehicle or the second vehicle) may generate the BEV representation is located in the first vehicle or the second vehicle.

In some examples, at least one processor of the one or more processors that is configured to generate the BEV representation is located outside of the first vehicle and the second vehicle. For examples, at least one processor of external processing system 180 may generate the BEV representation.

In some examples, external processing system 180 or processing system 100 may at least one of receive a first indication of the one or more first features or receive a second indication of the one or more second features. In some examples, processing system 100 may at least one of send a first indication of the one or more first features or receive a second indication of the one or more second features.

In some examples, the first vehicle data includes first grid-free kernels the second vehicle data includes second grid-free kernels. In some examples, as part of fusing the one or more first features and the one or more second features, external processing system 180 may fuse the first grid-free kernels and the second grid-free kernels. In some examples, the first grid-free kernels and the second grid-free kernels comprise variational autoencoder-Gaussian mixture model (VAE-GMM) kernels.

In some examples, the vehicle data includes at least one of vehicle pose, vehicle location, or vehicle trajectory. In some examples, external processing system 180 or processing system 100 may determine to not fuse a third one or more features from a third vehicle data. For example, external processing system 180 or processing system 100 may determine not to fuse features of grid-free kernels 1252N. In some examples, the third vehicle data is from a third vehicle (e.g., vehicle 1266N) of the plurality of vehicles as part of generating the BEV representation based on the at least one of vehicle pose, vehicle location, or vehicle trajectory. In some examples, as part of determining to not fuse the third one or more features, external processing system 180 or processing system 100 may determine that the third one or more features based on a determination that the third vehicle will be outside a neighborhood in less than or less than or equal to a predetermined threshold amount of time, the neighborhood including a geographical area including the plurality of vehicles. For example, external processing system 180 or processing system 100 may determine that vehicle 1266N will be outside of the neighborhood in less than K seconds.

In some examples, external processing system 180 or processing system 100 may generate a mask based on overlapping fields of view of at least one sensor system of the first vehicle and at least one sensor system of the second vehicle and apply the mask to a plurality of first features as part of determining the one or more first features and apply the mask to a plurality of second feature as part of determining the one or more second features.

In some examples, the BEV representation is a unified BEV representation for the plurality of vehicles. For example, the unified BEV representation may be based on information from multiple CAVs (e.g., multi-model BEV information) and may be used by one or more of the multiple CAVs, for example, to navigate. In some examples, the first vehicle data is based on first sensor data from a first plurality of sensor systems of the first vehicle and the second vehicle data is based on second sensor data from a second plurality of sensor systems of the second vehicle, wherein the first sensor data and the second sensor data have a different resolution.

In some examples, the first vehicle data is based on first sensor data from a first plurality of sensor systems of the first vehicle and the second vehicle data is based on second sensor data from a second plurality of sensor systems of the second vehicle, wherein at least one sensor system of the first plurality of sensor systems is of a different type (e.g., camera, LiDAR, radar, etc.) than each sensor system of the second plurality of sensor systems. For example, the first vehicle may include a multi-modal sensor set that is different than a multi-modal sensor set of the second vehicle. For example, the multi-model sensor set of the first vehicle may include a radar system, while the multi-model sensor set of the second vehicle may not.

In some examples, as part of obtaining vehicle data, external processing system 180 may obtain vehicle data generated over time. In such examples, the vehicle data includes information indicative of at least one of a change in pose of the first vehicle or a change in pose of the second vehicle. The change in pose of the first vehicle or the change in pose of the second vehicle may include a change in at least one of rotation or translation.

In some examples, a first feature of the one or more first features corresponds to a second feature of the one or more second features. In some examples, the first feature is represented with a different level of distortion than the second feature.

In some examples, a first feature of the one or more first features is representative of a dynamic object. In some examples, at least a portion of external processing system 180 resides in a cloud-computing environment.

In some examples, external processing system 180 (or processing system 100 of a third vehicle) may transmit BEV feature configuration information to the first vehicle and the second vehicle for configuring BEV processing of the first vehicle and the second vehicle. For example, BEV feature configuration information 1384 includes at least one of BEV feature vector size, a model index for a model to transform two-dimensional camera images to BEV feature vectors, or the model. In some examples, external processing system 180 or processing system 100 may receive, from the first vehicle, a BEV feature vector in accordance with the BEV feature vector size. The BEV feature vector may include a raw BEV feature vector or a compressed BEV feature vector. In some examples, the compressed BEV feature vector is compressed using at least one of quantization, pruning, hashing, or transformation. In some examples, the compressed BEV feature vector comprises soft BEV features or hard BEV features, wherein the soft BEV features include probabilities or likelihoods of object presence or object attributes, and wherein hard BEV features include binary or categorical representations of object presence or attributes.

In some examples, prior to fusing the one or more first features and the one or more second features, external processing system 180 or processing system 100 may compress the one or more first features and the one of more second features using at least one of quantization, pruning, hashing, or transformation.

In some examples, external processing system 180 or processing system 100 includes an intermediate collaboration system. For examples, external processing system 180 (or processing system 100 of a third vehicle) may receive, from the first vehicle, an indication of the one or more first features, and receive, from the second vehicle, an indication of the one or more second features. In some examples, as part of generating the BEV representation, external processing system 180 or processing system 100 may discretize grid-free kernels for the at least one vehicle. In some examples, external processing system 180 or processing system 100 may, prior to or as part of generating the BEV representation, align grids associated with the first vehicle and the second vehicle.

Additional aspects of the disclosure are detailed in numbered clauses below.

Clause 1. A system for processing data from a plurality of vehicles, the system comprising: one or more memories for storing vehicle data from each of the plurality of vehicles, the vehicle data being grid-free; and one or more processors in communication with the one or more memories, the one or more processors configured to: determine one or more first features from first vehicle data of the vehicle data, the first vehicle data being from a first vehicle of the plurality of vehicles; determine one or more second features from second vehicle data of the vehicle data, the second vehicle data being from a second vehicle of the plurality of vehicles; fuse the one or more first features and the one or more second features to generate fused features; generate a bird's-eye-view (BEV) representation based on the fused features; and send the BEV representation to at least one vehicle of the plurality of vehicles.

Clause 2. The system of clause 1, wherein the one or more processors are further configured to send the BEV representation to at least one vehicle of the plurality of vehicles.

Clause 3. The system of clause 1 or clause 2, wherein at least one processor of the one or more processors that is configured to generate the BEV representation is located in the first vehicle or the second vehicle.

Clause 4. The system of clause 1 or clause 2, wherein at least one processor of the one or more processors that is configured to generate the BEV representation is located outside of the first vehicle and the second vehicle.

Clause 5. The system of any of clauses 1-4, wherein the one or more processors are further configured to at least one of receive a first indication of the one or more first features or receive a second indication of the one or more second features.

Clause 6. The system of any of clauses 1-5, wherein the one or more processors are further configured to at least one of send a first indication of the one or more first features or receive a second indication of the one or more second features.

Clause 7. The system of any of clauses 1-7, wherein the first grid-free vehicle data comprises first grid-free kernels, wherein the second grid-free vehicle data comprises second grid-free kernels, and wherein as part of fusing the one or more first features and the one or more second features, the one or more processors are configured to fuse the first grid-free kernels and the second grid-free kernels.

Clause 8. The system of clause 7, wherein the first grid-free kernels and the second grid-free kernels comprise variational autoencoder-Gaussian mixture model (VAE-GMM) kernels.

Clause 9. The system of any of clauses 1-8, wherein the vehicle data comprises at least one of vehicle pose, vehicle location, or vehicle trajectory, and wherein the one or more processors are further configured to determine to not fuse a third one or more features from third vehicle data, the third vehicle data being from a third vehicle of the plurality of vehicles as part of generating the BEV representation based on the at least one of vehicle pose, vehicle location, or vehicle trajectory.

Clause 10. The system of clause 9, wherein as part of determining to not fuse the third one or more features, the one or more processors are configured to determine that the third one or more features based on a determination that the third vehicle will be outside a neighborhood in less than or less than or equal to a predetermined threshold amount of time, the neighborhood comprising a geographical area including the plurality of vehicles.

Clause 11. The system of any of clauses 1-10, wherein the one or more processors are further configured to: generate a mask based on overlapping fields of view of at least one sensor system of the first vehicle and at least one sensor system of the second vehicle; and apply the mask to a plurality of first features as part of determining the one or more first features and apply the mask to a plurality of second feature as part of determining the one or more second features.

Clause 12. The system of any of clauses 1-11, wherein the BEV representation is a unified BEV representation for the plurality of vehicles.

Clause 13. The system of any of clauses 1-12, wherein the first vehicle data is based on first sensor data from a first plurality of sensor systems of the first vehicle and the second vehicle data is based on second sensor data from a second plurality of sensor systems of the second vehicle, wherein the first sensor data and the second sensor data have a different resolution.

Clause 14. The system of any of clauses 1-13, wherein the first vehicle data is based on first sensor data from a first plurality of sensor systems of the first vehicle and the second vehicle data is based on second sensor data from a second plurality of sensor systems of the second vehicle, wherein at least one sensor system of the first plurality of sensor systems is of a different type than each sensor system of the second plurality of sensor systems.

Clause 15. The system of any of clauses 1-14, wherein as part of obtaining vehicle data, the one or more processors are configured to obtain vehicle data generated over time, wherein the vehicle data comprises information indicative of at least one of a change in pose of the first vehicle or a change in pose of the second vehicle, and wherein the change in pose of the first vehicle or the change in pose of the second vehicle comprise a change in at least one of rotation or translation.

Clause 16. The system of any of clauses 1-15, wherein a first feature of the one or more first features corresponds to a second feature of the one or more second features, and wherein the first feature is represented with a different level of distortion than the second feature.

Clause 17. The system of any of clauses 1-16, wherein a first feature of the one or more first features is representative of a dynamic object.

Clause 18. The system of any of clauses 1-17, wherein at least a portion of the system resides in a cloud-computing environment.

Clause 19. The system of any of clauses 1-18, wherein the one or more processors are further configured to transmit BEV feature configuration information to the first vehicle and the second vehicle for configuring BEV processing of the first vehicle and the second vehicle, wherein the BEV feature configuration information comprises at least one of BEV feature vector size, a model index for a model to transform two-dimensional camera images to BEV feature vectors, or the model.

Clause 20. The system of clause 19, wherein the one or more processors are further configured to receive, from the first vehicle, a BEV feature vector in accordance with the BEV feature vector size, wherein the BEV feature vector comprises a raw BEV feature vector or a compressed BEV feature vector.

Clause 21. The system of clause 20, wherein the compressed BEV feature vector is compressed using at least one of quantization, pruning, hashing, or transformation.

Clause 22. The system of clause 20 or clause 21, wherein the compressed BEV feature vector comprises soft BEV features or hard BEV features, wherein the soft BEV features comprise probabilities or likelihoods of object presence or object attributes, and wherein hard BEV features comprise binary or categorical representations of object presence or attributes.

Clause 23. The system of any of clauses 1-22, wherein the one or more processors are further configured to, prior to fusing the one or more first features and the one or more second features, compress the one or more first features and the one of more second features using at least one of quantization, pruning, hashing, or transformation.

Clause 24. The system of any of clauses 1-23, wherein the system comprises an intermediate collaboration system, wherein the one or more processors are further configured to: receive, from the first vehicle, an indication of the one or more first features; and receive, from the second vehicle, an indication of the one or more second features.

Clause 25. The system of any of clauses 1-24, wherein as part of generating the BEV representation, the one or more processors are configured to discretize grid-free kernels for at least one vehicle of the plurality of vehicles.

Clause 26. The system of any of clauses 1-25, wherein the one or more processors are further configured to, prior to or as part of generating the BEV representation, align grids associated with the first vehicle and the second vehicle.

Clause 27. A method for processing data from a plurality of vehicles, the method comprising: obtaining vehicle data from each of the plurality of vehicles, the vehicle data being grid-free; determining one or more first features from first vehicle data of the vehicle data, the first vehicle data being from a first vehicle of the plurality of vehicles; determining one or more second features from second vehicle data of the vehicle data, the second vehicle data being from a second vehicle of the plurality of vehicles; fusing the one or more first features and the one or more second features to generate fused features; generating a bird's-eye-view (BEV) representation based on the fused features

Clause 28. The method of clause 27, further comprising sending the BEV representation to at least one vehicle of the plurality of vehicles.

Clause 29. The method of clause 27 or clause 28, wherein generating the BEV representation occurs in the first vehicle or the second vehicle.

Clause 30. The method of clause 27 or clause 28, wherein generating the BEV representation occurs outside of the first vehicle and the second vehicle.

Clause 31. The method of any of clauses 27-30, further comprising at least one of receiving a first indication of the one or more first features or receiving a second indication of the one or more second features.

Clause 32. The method of any of clauses 27-31, further comprising to at least one of sending a first indication of the one or more first features or receiving a second indication of the one or more second features.

Clause 33. The method of any of clauses 27-32, wherein the vehicle data comprises first grid-free kernels, wherein the second vehicle data comprises second grid-free kernels, and wherein fusing the one or more first features and the one or more second features, comprises fusing the first grid-free kernels and the second grid-free kernels.

Clause 34. The method of clause 33, wherein the first grid-free kernels and the second grid-free kernels comprise variational autoencoder-Gaussian mixture model (VAE-GMM) kernels.

Clause 35. The method of any of clauses 27-34, wherein the vehicle data comprises at least one of vehicle pose, vehicle location, or vehicle trajectory, further comprising determining to not fuse a third one or more features from third vehicle data, the third vehicle data being from a third vehicle of the plurality of vehicles as part of generating the BEV representation based on the at least one of vehicle pose, vehicle location, or vehicle trajectory.

Clause 36. The method of clause 35, wherein determining to not fuse the third one or more features comprises determining that the third vehicle will be outside a neighborhood in less than or less than or equal to a predetermined threshold amount of time, the neighborhood comprising a geographical area including the plurality of vehicles.

Clause 37. The method of any of clauses 27-36, further comprising: generating a mask based on overlapping fields of view of at least one sensor system of the first vehicle and at least one sensor system of the second vehicle; and applying the mask to a plurality of first features as part of determining the one or more first features and applying the mask to a plurality of second feature as part of determining the one or more second features.

Clause 38. The method of any of clauses 27-37, wherein the BEV representation is a unified BEV representation for the plurality of vehicles.

Clause 39. The method of any of clauses 27-38, wherein the first vehicle data is based on first sensor data from a first plurality of sensor systems of the first vehicle and the second vehicle data is based on second sensor data from a second plurality of sensor systems of the second vehicle, wherein the first sensor data and the second sensor data have a different resolution.

Clause 40. The method of any of clauses 27-39, wherein the first vehicle data is based on first sensor data from a first plurality of sensor systems of the first vehicle and the second vehicle data is based on second sensor data from a second plurality of sensor systems of the second vehicle, wherein at least one sensor system of the first plurality of sensor systems is of a different type than each sensor system of the second plurality of sensor systems.

Clause 41. The method of any of clauses 27-40, wherein obtaining vehicle data comprises obtaining vehicle data generated over time, wherein the vehicle data comprises information indicative of at least one of a change in pose of the first vehicle or a change in pose of the second vehicle, and wherein the change in pose of the first vehicle or the change in pose of the second vehicle comprise a change in at least one of rotation or translation.

Clause 42. The method of any of clauses 27-41, wherein a first feature of the one or more first features corresponds to a second feature of the one or more second features, and wherein the first feature is represented with a different level of distortion than the second feature.

Clause 43. The method of any of clauses 27-42, wherein a first feature of the one or more first features is representative of a dynamic object.

Clause 44. The method of any of clauses 27-43, wherein at least a portion of the method is practiced in a cloud-computing environment.

Clause 45. The method of any of clauses 27-44, further comprising transmitting BEV feature configuration information to the first vehicle and the second vehicle for configuring BEV processing of the first vehicle and the second vehicle, wherein the BEV feature configuration information comprises at least one of BEV feature vector size, a model index for a model to transform two-dimensional camera images to BEV feature vectors, or the model.

Clause 46. The method of clause 45, further comprising receiving, from the first vehicle, a BEV feature vector, wherein the BEV feature vector comprises a raw BEV feature vector in accordance with the BEV feature vector size or a compressed BEV feature vector.

Clause 47. The method of clause 46, wherein the compressed BEV feature vector is compressed using at least one of quantization, pruning, hashing, or transformation.

Clause 48. The method of clause 46 or clause 47, wherein the compressed BEV feature vector comprises soft BEV features or hard BEV features, wherein the soft BEV features comprise probabilities or likelihoods of object presence or object attributes, and wherein hard BEV features comprise binary or categorical representations of object presence or attributes.

Clause 49. The method of any of clauses 27-48, further comprising, prior to fusing the one or more first features and the one or more second features, compressing the one or more first features and the one of more second features using at least one of quantization, pruning, hashing, or transformation.

Clause 50. The method of any of clauses 27-49, wherein the method comprises an intermediate collaboration method and wherein obtaining the vehicle data comprises: receiving, from the first vehicle, an indication of the one or more first features; and receiving, from the second vehicle, an indication of the one or more second features.

Clause 51. The method of any of clauses 27-50, wherein generating the BEV representation comprises discretizing grid-free kernels for at least one vehicle of the plurality of vehicles.

Clause 52. The method of any of clauses 27-51, further comprising, prior to or as part of generating the BEV representation, aligning grids associated with the first vehicle and the second vehicle.

Clause 53. Non-transitory computer-readable media storing instructions, which, when executed by one or more processors, cause the one or more processors to: obtain vehicle data from each of the plurality of vehicles, the vehicle data being grid-free; determine one or more first features from first vehicle data of the vehicle data, the first vehicle data being from a first vehicle of the plurality of vehicles; determine one or more second features from second vehicle data of the vehicle data, the second vehicle data being from a second vehicle of the plurality of vehicles; fuse the one or more first features and the one or more second features to generate fused features; and generate a bird's-eye-view (BEV) representation based on the fused features.

Clause 54. A system for processing data from a plurality of vehicles, the system comprising: means for obtaining vehicle data from each of the plurality of vehicles, the vehicle data being grid-free; means for determining one or more first features from first vehicle data of the vehicle data, the first vehicle data being from a first vehicle of the plurality of vehicles; means for determining one or more second features from second vehicle data of the vehicle data, the second vehicle data being from a second vehicle of the plurality of vehicles; means for fusing the one or more first features and the one or more second features to generate fused features; means for generating a bird's-eye-view (BEV) representation based on the fused features.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system for processing data from a plurality of vehicles, the system comprising:
one or more memories for storing vehicle data from each of the plurality of vehicles, the vehicle data being grid-free; and
one or more processors in communication with the one or more memories, the one or more processors configured to:
determine one or more first features from first vehicle data of the vehicle data, the first vehicle data being from a first vehicle of the plurality of vehicles;
determine one or more second features from second vehicle data of the vehicle data, the second vehicle data being from a second vehicle of the plurality of vehicles;
fuse the one or more first features and the one or more second features to generate fused features; and
generate a bird's-eye-view (BEV) representation based on the fused features.

2. The system of claim 1, wherein the one or more processors are further configured to send the BEV representation to at least one vehicle of the plurality of vehicles.

3. The system of claim 1, wherein at least one processor of the one or more processors that is configured to generate the BEV representation is located in the first vehicle or the second vehicle.

4. The system of claim 1, wherein at least one processor of the one or more processors that is configured to generate the BEV representation is located outside of the first vehicle and the second vehicle.

5. The system of claim 1, wherein the one or more processors are further configured to at least one of receive a first indication of the one or more first features or receive a second indication of the one or more second features.

6. The system of claim 1, wherein the one or more processors are further configured to at least one of send a first indication of the one or more first features or receive a second indication of the one or more second features.

7. The system of claim 1, wherein the first vehicle data comprises first grid-free kernels, wherein the second vehicle data comprises second grid-free kernels, and wherein as part of fusing the one or more first features and the one or more second features, the one or more processors are configured to fuse the first grid-free kernels and the second grid-free kernels.

8. The system of claim 7, wherein the first grid-free kernels and the second grid-free kernels comprise variational autoencoder-Gaussian mixture model (VAE-GMM) kernels.

9. The system of claim 1, wherein the vehicle data comprises at least one of vehicle pose, vehicle location, or vehicle trajectory, and wherein the one or more processors are further configured to determine to not fuse a third one or more features from third vehicle data, the third vehicle data being from a third vehicle of the plurality of vehicles as part of generating the BEV representation based on the at least one of vehicle pose, vehicle location, or vehicle trajectory.

10. The system of claim 9, wherein as part of determining to not fuse the third one or more features, the one or more processors are configured to determine that the third one or more features based on a determination that the third vehicle will be outside a neighborhood in less than or less than or equal to a predetermined threshold amount of time, the neighborhood comprising a geographical area including the plurality of vehicles.

11. The system of claim 1, wherein the one or more processors are further configured to:
generate a mask based on overlapping fields of view of at least one sensor system of the first vehicle and at least one sensor system of the second vehicle; and
apply the mask to a plurality of first features as part of determining the one or more first features and apply the mask to a plurality of second feature as part of determining the one or more second features.

12. The system of claim 1, wherein the BEV representation is a unified BEV representation for the plurality of vehicles.

13. The system of claim 1, wherein the first vehicle data is based on first sensor data from a first plurality of sensor systems of the first vehicle and the second vehicle data is based on second sensor data from a second plurality of sensor systems of the second vehicle, wherein the first sensor data and the second sensor data have a different resolution.

14. The system of claim 1, wherein the first vehicle data is based on first sensor data from a first plurality of sensor systems of the first vehicle and the second vehicle data is based on second sensor data from a second plurality of sensor systems of the second vehicle, wherein at least one sensor system of the first plurality of sensor systems is of a different type than each sensor system of the second plurality of sensor systems.

15. The system of claim 1, wherein the one or more processors are configured to obtain vehicle data generated over time, wherein the vehicle data comprises information indicative of at least one of a change in pose of the first vehicle or a change in pose of the second vehicle, and wherein the change in pose of the first vehicle or the change in pose of the second vehicle comprise a change in at least one of rotation or translation.

16. The system of claim 1, wherein a first feature of the one or more first features corresponds to a second feature of the one or more second features, and wherein the first feature is represented with a different level of distortion than the second feature.

17. The system of claim 1, wherein a first feature of the one or more first features is representative of a dynamic object.

18. The system of claim 1, wherein at least a portion of the system resides in a cloud-computing environment.

19. The system of claim 1, wherein the one or more processors are further configured to transmit BEV feature configuration information to the first vehicle and the second vehicle for configuring BEV processing of the first vehicle and the second vehicle, wherein the BEV feature configuration information comprises at least one of BEV feature vector size, a model index for a model to transform two-dimensional camera images to BEV feature vectors, or the model.

20. The system of claim 19, wherein the one or more processors are further configured to receive, from the first vehicle, a BEV feature vector in accordance with the BEV feature vector size, wherein the BEV feature vector comprises a raw BEV feature vector or a compressed BEV feature vector.

21. The system of claim 20, wherein the compressed BEV feature vector is compressed using at least one of quantization, pruning, hashing, or transformation.

22. The system of claim 20, wherein the compressed BEV feature vector comprises soft BEV features or hard BEV features, wherein the soft BEV features comprise probabilities or likelihoods of object presence or object attributes, and wherein hard BEV features comprise binary or categorical representations of object presence or attributes.

23. The system of claim 1, wherein the one or more processors are further configured to, prior to fusing the one or more first features and the one or more second features, compress the one or more first features and the one of more second features using at least one of quantization, pruning, hashing, or transformation.

24. The system of claim 1, wherein the system comprises an intermediate collaboration system, wherein the one or more processors are further configured to:
receive, from the first vehicle, an indication of the one or more first features; and
receive, from the second vehicle, an indication of the one or more second features.

25. The system of claim 1, wherein as part of generating the BEV representation, the one or more processors are configured to discretize grid-free kernels for at least one vehicle of the plurality of vehicles.

26. The system of claim 1, wherein the one or more processors are further configured to, prior to or as part of generating the BEV representation, align grids associated with the first vehicle and the second vehicle.

27. A method for processing data from a plurality of vehicles, the method comprising:
obtaining vehicle data from each of the plurality of vehicles, the vehicle data being grid-free;
determining one or more first features from first vehicle data of the vehicle data, the first vehicle data being from a first vehicle of the plurality of vehicles;
determining one or more second features from second vehicle data of the vehicle data, the second vehicle data being from a second vehicle of the plurality of vehicles;
fusing the one or more first features and the one or more second features to generate fused features;
generating a bird's-eye-view (BEV) representation based on the fused features; and
sending the BEV representation to at least one vehicle of the plurality of vehicles.

28. The method of claim 27, wherein the first vehicle data comprises first grid-free kernels the second vehicle data comprises second grid-free kernels, and wherein fusing the one or more first features and the one or more second features, comprises fusing the first grid-free kernels and the second grid-free kernels.

29. The method of claim 28, wherein the first grid-free kernels and the second grid-free kernels comprise variational autoencoder-Gaussian mixture model (VAE-GMM) kernels.

30. A system for processing data from a plurality of vehicles, the system comprising:
means for obtaining vehicle data from each of the plurality of vehicles, the vehicle data being grid-free;
means for determining one or more first features from first vehicle data of the vehicle data, the first vehicle data being from a first vehicle of the plurality of vehicles;
means for determining one or more second features from second vehicle data of the vehicle data, the second vehicle data being from a second vehicle of the plurality of vehicles;
means for fusing the one or more first features and the one or more second features to generate fused features;
means for generating a BEV representation based on the fused features; and means sending the BEV representation to at least one vehicle of the plurality of vehicles.
